(19) United States
(12) Patent Application Publication
(10) Pub. No.: US 2024/0114963 A1
(43) Pub. Date: Apr. 11, 2024

(54) AEROSOL PROVISION DEVICE

(71) Applicant: NICOVENTURES TRADING LIMITED, London (GB)

(72) Inventors: Patrick MOLONEY, London (GB); Anton KORUS, Derbyshire (GB)

(21) Appl. No.: 18/263,932

(22) PCT Filed: Feb. 10, 2022
(86) PCT No.: PCT/EP2022/053285

§ 371 Date: Aug. 2, 2023

(30) Foreign Application Priority Data
Feb. 10, 2021 (GB) 2101845.2

(51) Int. Cl. A24F 40/465; A24D 1/20; A24F 40/20; H05B 6/10; H05B 6/44

(52) U.S. Cl. CPC A24F 40/465; A24D 1/20; A24F 40/20; H05B 6/105; H05B 6/44

(57) ABSTRACT

An aerosol provision device is disclosed having one or more inductor coils wherein, in use, an article for use with an aerosol provision device is interlaced or otherwise located within or between at least one of the one or more inductor coils or windings of the one or more inductor coils.

### PRIORITY CLAIM

The present application is a National Phase entry of PCT Application No. PCT/EP2022/053285, filed Feb. 10, 2022, which claims priority from GB Application No. 2101845.2, filed Feb. 10, 2021, each of which is hereby fully incorporated herein by reference.

### TECHNICAL FIELD

The present disclosure relates to an aerosol provision device, an aerosol provision system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

Conventional aerosol provision devices comprise a cylindrical heating chamber into which a rod shaped consumable is inserted.

Next generation devices are contemplated wherein a consumable comprising a flat aluminum substrate may be inserted into an aerosol provision device. However, a problem which such contemplated arrangements is that inductive heating of the aluminum consumable may cause the consumable to move in an undesirable manner relative to the aerosol provision device.

It is therefore desired to provide an improved aerosol provision device.

### SUMMARY

According to an aspect there is provided an aerosol provision device comprising: an aerosol generator comprising one or more inductor coils; wherein, in use, an article for use with an aerosol provision device is interlaced or otherwise located within or between at least one of the one or more inductor coils or windings of one or more inductor coils.

The aerosol provision device is arranged so that an article may be interlaced between or otherwise provided between the loops or windings of an inductor coil so that the article is generally provided in a plane which is parallel to a single loop or winding of the inductor coil. It will be appreciated that this orientation is substantially different to conventional arrangements wherein an article in the form of a rod is inserted in a longitudinal manner into a heating zone of an aerosol provision device wherein the heating zone is a longitudinal cavity formed within the body of the aerosol provision device.

It is not known to insert a different type of article, namely a flat aluminum sheet having aerosol generating material deposited thereon, so that the article is positioned between the windings of an inductor coil in an interlaced manner.

The positioning of an article within or between the windings of an inductor coil helps to stabilize the article and substantially prevents any undesired movement of the article.

Optionally, a plurality articles for use with an aerosol provision device may be interlaced or otherwise located within or between at least one of the one or more inductor coils or windings of one or more inductor coils.

The one or more inductor coils may be arranged so as to form a heating zone within a region defined by the one or more inductor coils. The heating zone may have a longitudinal axis. The article for use with an aerosol provision device may be arranged so as to be inserted axially in a direction which is substantially orthogonal to the longitudinal axis.

The article for use with an aerosol provision device may be arranged to be inserted in a plane which is substantially parallel with a plane in which a single winding of the one of one or more inductor coils lies.

Optionally, the aerosol generator may comprise a plurality of inductor coils, wherein each article of the plurality articles for use with an aerosol provision device is interlaced or otherwise located within or between a respective inductor coil of the plurality of inductor coils or windings of one or more inductor coils.

Optionally, the aerosol provision device may comprise one or more susceptors.

Optionally, the article or the plurality of articles for use with an aerosol provision device may be positioned in proximity to one or more of the susceptors.

Optionally, the one or more susceptors may be located within or between the windings of the one or more inductor coils.

Optionally, the aerosol provision device may comprise a first inductor coil and a second inductor coil, wherein, in use, an article for use with an aerosol provision device may be interlaced or otherwise located within or between the first inductor coil, wherein the second inductor coil may comprise a central inductor coil positioned radially inwards or outwards of the first inductor coil.

Optionally, the article for use with an aerosol provision device may be interlaced or otherwise located within or between the first inductor coil such that there may be a substantially equal number of turns of the first inductor coil above and below the article.

Optionally, the central inductor coil may be positioned radially inwards of the first inductor coil.

Optionally, the central inductor coil may be positioned radially outwards of the first inductor coil.

Optionally, the one or more inductor coils may comprise a first inductor coil and a second inductor coil wherein, in use, an article for use with an aerosol provision device may be located equidistant between the first and second inductor coils, wherein the article does not penetrate inside the first and second inductor coils.

Optionally, the first and second inductor coils may be connected in series.

Optionally, the first and second inductor coils may be not electrically connected or may be substantially electrically independent or isolated from one another.

Optionally, the article for use with an aerosol provision device defines a first face profile and a second face profile, wherein, in use, the first face profile faces the first inductor coil and the second face profile faces the second inductor coil. The first face profile and/or the second face profile may be substantially planar.

Optionally, the aerosol provision device may comprise a device or otherwise be configured for supplying electrical power to the one or more inductor coils, the device for supplying electrical power being configured to allow an oscillating electrical current to flow in the one or more inductor coils.

Optionally, the device for supplying electrical power to the one or more inductor coils may comprise one or more sources of electrical power.

Optionally, the device for supplying electrical power to the one or more inductor coils may comprise one or more electrical connectors wherein, in use, the one or more electrical connectors connect to one or more electrical power sources for use with an aerosol provision device, wherein the one or more electrical power sources supply electrical power to the one or more inductor coils through the one or more electrical connectors.

Optionally, the aerosol provision device may comprise a plurality of inductor coils and wherein the device for supplying electrical power to the one or more inductor coils may be configured to supply electrical power independently to the plurality of inductor coils.

Optionally, at least one of the one or more inductor coils may comprise a planar non-spiral inductor coil.

Optionally, at least one of the one or more inductor coils comprising a planar non-spiral inductor coil may have a substantially square shape or may be substantially rectangular.

Optionally, the aerosol provision device may comprise two or more planar non-spiral inductor coils.

Optionally, the planar non-spiral inductor coil may comprise a plurality of mandrel loops, the plurality of mandrel loops being arranged in a multiple layer configuration.

Optionally, the mandrel loops may comprise single turn coils.

Optionally, the mandrel loops may comprise four turn coils.

Optionally, the mandrel loops may be disposed on a printed circuit board (PCB).

Optionally, the aerosol provision device may further comprise a flux concentrator.

Optionally, the flux concentrator may comprise ferrite material and/or may be a continuous sheet or strip of ferrite material.

Optionally, at least one of the one or more inductor coils may comprise an electrically-conductive element, wherein the element may comprise an electrically-conductive first portion coincident with a first plane, an electrically-conductive second portion coincident with a second plane that may be spaced from the first plane, and an electrically-conductive connector that electrically connects the first portion to the second portion.

Optionally, the first portion may be a first partial annulus and the second portion may be a second partial annulus.

Optionally, the first portion or first partial annulus may be a first circular arc, and the second portion or second partial annulus may be a second circular arc.

Optionally, when viewed in a direction orthogonal to the first plane, the first and second portions or partial annuli may extend in opposite senses of rotation from the electrically-conductive connector.

Optionally, when viewed in a direction orthogonal to the first plane, the first portion or first partial annulus may overlap, only partially, the second portion or second partial annulus.

Optionally, when viewed in a direction orthogonal to the first plane, the first portion or first partial annulus may at least partially overlap the electrically-conductive connector.

Optionally, the first and second planes may be flat planes.

Optionally, a distance between the first and second planes measured in a direction orthogonal to the first and second planes may be less than 2 mm.

Optionally, the first and second portions or partial annuli together define at least 0.9 turns about an axis be that is orthogonal to the first and second planes.

Optionally, the element may comprise further electrically-conductive portions or electrically-conductive partial annuli that may be coincident with respective spaced-apart planes.

Optionally, a total number of turns, about an axis, defined by all of the electrically-conductive portions or partial annuli of the element together may be between 1 and 10.

Optionally, a distance between each adjacent pair of the portions or partial annuli of the element may be equal to, or differs by less than 10% from, a distance between each other adjacent pair of the portions or partial annuli of the element.

Optionally, each of the first and second portions or partial annuli has a thickness, measured in a direction orthogonal to the first plane, of between 10 micrometers and 200 micrometers.

Optionally, at least one of the one or more inductor coils may comprise a coil having a pitch of less than 2 mm.

Optionally, the aerosol provision device may further comprise an electrically-insulating support having opposite first and second sides, wherein the first portion or first partial annulus may be on the first side of the support, and the second portion or second partial annulus is on the second side of the support.

Optionally, the electrically-insulating support may have a through-hole that may be radially-inward of, and coaxial with, the first and second portions or partial annuli.

Optionally, the electrically-conductive connector of the inductor extends through the support.

Optionally, the support has a thickness of between 0.2 mm and 2 mm.

Optionally, the aerosol provision device further comprises a printed circuit board, wherein the support may be a non-electrically-conductive substrate of the printed circuit board and the first and second portions or partial annuli may be tracks on the substrate.

Optionally, at least one of the one or more inductor coils may comprise a layered inductor arrangement, wherein the layered inductor arrangement may comprise a plurality of layers, optionally three or more layers.

Optionally, the layered inductor arrangement may comprise an electrically-conductive element, the electrically-conductive element comprising: a first layer comprising an electrically-conductive first portion; a second layer comprising an electrically-conductive second portion, wherein the second layer may be spaced from the first layer along a first direction by a first spacing; and a third layer comprising an electrically-conductive third portion, wherein the third layer that may be spaced from the second layer along a second direction by a second spacing.

Optionally, the layered inductor arrangement comprises: a first electrically-conductive connector that electrically connects the first portion to the second portion; and a second electrically-conductive connector that electrically connects the second portion to the third portion.

Optionally, the first layer may be coincident with a first plane, the second layer may be coincident with a second plane, and the third layer may be coincident with a third plane.

Optionally, at least one of the first plane, the second plane, and the third plane may be flat planes, and optionally wherein the first direction may be perpendicular to the first plane and/or the second direction may be perpendicular to the second plane.

Optionally, the first, second, and third planes may be parallel flat planes.

Optionally, the second direction along which the third layer may be spaced from the second layer may be at an angle other than 180 degrees relative to the first direction along which the second layer may be spaced from the first layer such that the layered inductor arrangement may comprise a staggered structure formed from the first, second, and third portions.

Optionally, the second direction along which the third layer may be spaced from the second layer may be in a substantially opposite direction to the first direction along which the second layer may be spaced from the first layer such that the layered inductor arrangement may comprise a staggered structure formed from the first, second, and third portions.

Optionally, the first spacing and the second spacing may have equal lengths.

Optionally, the first spacing and the second spacing may have different lengths.

Optionally, at least one of the first portion, the second portion, and the third portions comprise either a spiral, an irregular spiral, an annulus, a partial spiral, a partial irregular spiral, a partial annulus, a non-spiral or combinations thereof.

Optionally, the spiral, the irregular spiral, the partial spiral, the partial irregular spiral, the partial annulus, or combinations thereof may comprise a tail or vias.

Optionally, the first portion may define at least a first partial turn about a first point on the first plane; and/or the second portion defines at least a second partial turn about a second point on the second plane; and/or the third portion defines at least a third partial turn about a third point on the third plane.

Optionally, the first partial turn, and/or the second partial turn, and/or a third partial turn comprise less than one full turn.

Optionally, the first partial turn, and/or the second partial turn, and/or a third partial turn comprise more than one full turn.

Optionally, the first point and the second point lie on a first axis coincident with the first direction, and/or wherein the second point and the third point lie on a second axis coincident with the second direction.

Optionally, the partial spiral may comprise a part of: (i) a circular or ovular spiral; (ii) a square or rectangular spiral; (iii) a trapezoidal spiral; or (iv) a triangular spiral.

Optionally, the spiral comprises: (i) a circular or ovular spiral; (ii) a square or rectangular spiral; (iii) a trapezoidal spiral; or (iv) a triangular spiral.

Optionally, wherein the annulus comprises: (i) a circle or oval; (ii) a square or rectangle; (iii) a trapezoid; or (iv) a triangle; (v) regular polygon; (vi) irregular polygon.

Optionally, the partial annulus may comprise a part of: (i) a circle or oval; (ii) a square or rectangle; (iii) a trapezoid; or (iv) a triangle; (v) regular polygon; (vi) irregular polygon.

Optionally, the first layer and the third layer may be coincident with the same plane.

Optionally, the first layer and the third layer may be different regions of the same layer.

Optionally, one of the first portion and the third portion may be positioned radially inside of the other of the first portion and the third portion.

Optionally, at least one of the first portion and the third portion at least partially overlaps the second portion when viewed from a perspective face-on to the layers.

Optionally, the aerosol provision device comprising one or more tracks comprising magnetic material, wherein the one or more tracks may be located within or between the staggered structure.

Optionally, the magnetic material may comprise ferrite.

Optionally, at least one of the one or more inductor coils may comprise one or more conically shaped inductor coil(s).

Optionally, the conically shaped inductor coil may have a constant pitch.

According to alternative arrangement the conically shaped inductor coil may have a varying pitch. The varying pitch of the conically shaped inductor coil may be configured to provide a uniform inductive coupling or constant magnetic flux through a susceptor, optionally wherein the susceptor may be a flat susceptor.

Optionally, the conically shaped inductor coil may have a shorter conical height relative to a conical base width.

Optionally, the conically shaped inductor coil may comprise a coil of conducting material comprising a projected shape of: (i) a circular spiral; (ii) a square or rectangular spiral; (iii) a trapezoidal spiral; or (iv) a triangular spiral; and wherein the conically shaped inductor coil may comprise a conical base and the projected shape is the shape formed from projecting the coil onto the conical base.

Optionally, the projected shape may comprise at least one of: (i) a rectilinear side; (ii) a curvilinear side; or (iii) a mixture thereof.

Optionally, the conically shaped inductor coil has a conical axis and a conical base, wherein the conically shaped inductor coil has a cone apex, and the conical axis may be in a straight line passing through the apex and the center of the conical base.

Optionally, the conical axis may be perpendicular to the conical base.

Optionally, the conical axis may be at an angle other than 90 degrees to the conical base.

Optionally, the conically shaped inductor coil may comprise a coil of conducting material, and the coil of conducting material has a thickness or cross-sectional area which either: (i) varies along the coil; or (ii) may be uniform along the coil.

Optionally, the conducting material may be substantially uniform along the length of the coil. Alternatively, the conducting material may comprise a composition which varies along the length of the coil.

The conically shaped inductor coil may be formed around a curved plane or three dimensional surface.

Optionally, the curved plane or three dimensional surface may comprise a cylinder.

Optionally, the conically shaped inductor coil may comprise a conical base, and wherein the conical base may be formed around the curved plane or three dimensional surface.

Optionally, the aerosol provision device may comprise a plurality of conically shaped inductor coils.

Optionally, the aerosol provision device may comprise a conically shaped bifilar inductor coil, wherein the bifilar coil may comprise two or more closely spaced parallel windings.

Optionally, at least one of the one or more inductor coils may comprise a wrapped planar coil comprising a planar shaped inductor coil wrapped into a cylindrical form, optionally wherein the wrapped planar coil may be embedded in a substrate.

Optionally, the wrapped planar coil may be configured to retain its structure in the substrate.

Optionally, the substrate may be a resin.

Optionally, the one or more inductor coils may be arranged to generate a varying magnetic field and wherein the aerosol provision device further comprises one or more susceptors which are heated by the varying magnetic field.

Optionally, the one or more susceptors may be arranged and adapted to heat not burn aerosol generating material provided in the article or the plurality of articles for use with an aerosol provision device.

Optionally, the one or more susceptors may be arranged and adapted to generate aerosol from aerosol generating material provided in the article or the plurality of articles for use with an aerosol provision device.

According to another aspect there is provided an aerosol provision system comprising: an aerosol provision device as described above; and an article or a plurality of articles comprising aerosol generating material.

Optionally, the article or the plurality of articles may be located within or between windings of the one or more inductor coils.

Optionally, the article or the plurality of articles are substantially planar.

Optionally, the article or the plurality articles have an article cross-section which substantially conforms to an inductor coil cross-section of at least one of the one or more inductor coils.

Optionally, at least one of the plurality articles has a first article cross-section which may be different to a second article cross-section of at least one other of the plurality articles, wherein at least one of the first article cross-section and the second article cross-section substantially conforms to an inductor coil cross-section of the one or more inductor coils.

Optionally, the aerosol provision device may comprise a plurality of inductor coils, wherein each article of the plurality articles has an article cross-section which substantially conforms to a respective inductor coil cross-section of the plurality of inductor coils.

Optionally, each article with a particular article cross-section may be located within or between the windings of an inductor coil with an inductor coil cross-section to which the particular article cross-section substantially conforms.

Optionally, the article or the one or more articles located within or between the windings of the one or more inductor coils may substantially trace or track the windings of the one or more inductor coils.

Optionally, one or more susceptors may be located within or between the windings of the one or more inductor coils substantially trace or track the windings of the one or more inductor coils.

Optionally, the article or the plurality of articles comprise one or more susceptors.

Optionally, the article or the plurality of are inserted into the aerosol provision device so that at least a portion of one of the one or more susceptor elements may be located in close proximity to at least a portion of the one or more inductor coils.

Optionally, the article or the plurality of articles comprise aerosol generating material.

Optionally, the aerosol generating material may be provided: (i) as a solid; (ii) as a liquid; (iii) in the form of a gel; (iv) in the form of a thin film substrate; (v) in the form of a thin film substrate having multiple regions; or (vi) in the form of a thin film substrate having multiple regions, wherein at least two of the regions comprise aerosol generating material having different compositions.

According to another aspect there is provided a method of generating an aerosol comprising: providing an aerosol provision device having one or more inductor coils; interlacing or otherwise locating an article for use with an aerosol provision device within or between at least one of the one or more inductor coils or the windings of one or more inductor coils, wherein the article comprises aerosol generating material; and energizing the one or more inductor coils or windings.

### BRIEF DESCRIPTION OF THE DRAWINGS

Various embodiments will now be described, by way of example only, and with reference to the accompanying drawings, in which:

FIG. 1 shows a schematic side view of an example of an aerosol provision system.

FIG. 2 is a flow diagram showing an example of a method of heating aerosol generating material.

FIG. 3 is a flow diagram showing another example of a method of heating aerosol generating material.

FIG. 4 shows an arrangement comprising shown an inductor coil and an article.

FIG. 5 shows an arrangement wherein an article is interlaced with more than one inductor coil simultaneously.

FIG. 6 shows an arrangement wherein the aerosol provision device comprises a first inductor coil and a second inductor coil comprising a central inductor coil.

FIG. 7 shows an arrangement comprising a first inductor coil and a second inductor coil wherein, in use, an article is located equidistant between the first and second inductor coils.

FIG. 8 shows a schematic perspective view of a planar non-spiral coil which is in the form of a mandrel loop, formed onto a PCB, according to an arrangement.

FIG. 9 shows a cross-sectional side view of an inductor coil of a heating unit according to an arrangement.

FIG. 10 shows a schematic perspective view of an inductor according to an arrangement.

FIG. 11 shows a layered inductor arrangement according to an arrangement.

FIG. 12 shows a layered inductor arrangement comprising four layers according to an arrangement.

FIG. 13 shows a perspective view of a conically shaped induction coil according to an arrangement.

FIG. 14 shows a side-on-view of a conically shaped induction coil according to an arrangement.

FIG. 15 shows an inductor coil which is a flat or planar inductor coil formed around or wrapped around a cylinder.

FIG. 16A shows a plan view of a planar aerosol generating article according to an arrangement, FIG. 16B shows an end-on view of the aerosol generating article and shows a plurality of susceptors embedded into the aerosol generating article and FIG. 16C shows a side view of the aerosol generating article and shows a plurality of susceptors embedded into the aerosol generating article.

### DETAILED DESCRIPTION OF THE DRAWINGS

As used herein, the term “aerosolizable material”, also referred to as aerosol generating material, includes materials that provide volatilized components upon heating, typically in the form of vapor or an aerosol. “Aerosolizable material” may be a non-tobacco-containing material or a tobacco-containing material. “Aerosolizable material” may, for example, include one or more of tobacco per se, tobacco derivatives, expanded tobacco, reconstituted tobacco, tobacco extract, homogenized tobacco or tobacco substitutes. The aerosolizable material can be in the form of ground tobacco, cut rag tobacco, extruded tobacco, reconstituted tobacco, reconstituted aerosolizable material, liquid, gel, gelled sheet, powder, or agglomerates, or the like. “Aerosolizable material” also may include other, non-tobacco, products, which, depending on the product, may or may not contain nicotine. “Aerosolizable material” may comprise one or more humectants, such as glycerol or propylene glycol.

As used herein, the term “sheet” denotes an element having a width and length substantially greater than a thickness thereof. The sheet may be a strip, for example.

As used herein, the term “heating material” or “heater material” refers to material that is heatable by penetration with a varying magnetic field.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

In one example, the susceptor is in the form of a closed circuit. It has been found that, when the susceptor is in the form of a closed electrical circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule and magnetic hysteresis heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

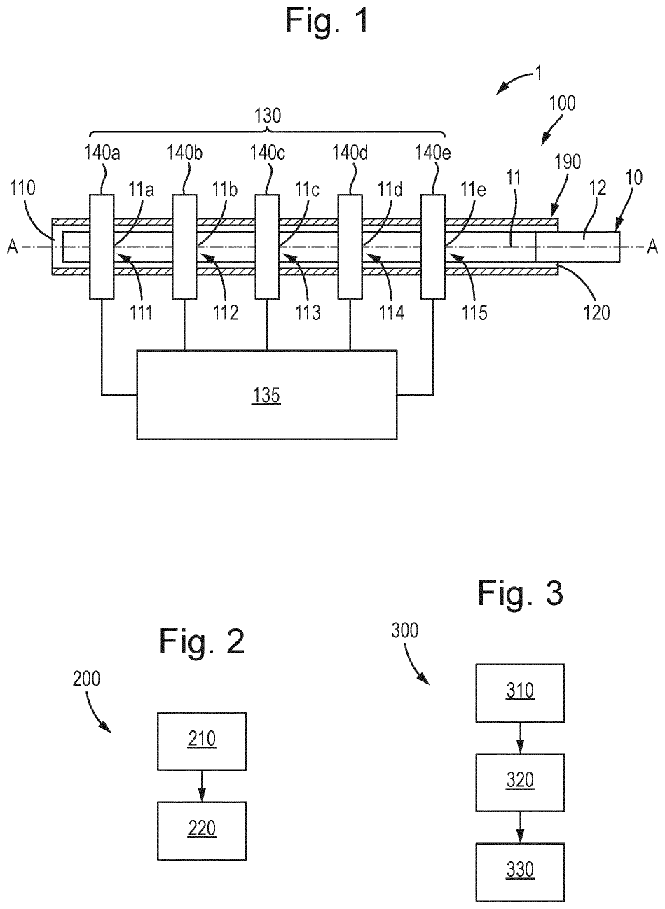

Referring to FIG. 1, there is shown a schematic cross-sectional side view of an example of an aerosol provision system 1. The aerosol provision system 1 may comprise an aerosol provision device 100 and an article 10 comprising aerosol generating material 11. The aerosol generating material 11 may, for example, be of any of the types of aerosol generating material discussed herein.

In some examples, the aerosol generating material 11 is a non-liquid material. In some examples, the aerosol generating material 11 is a gel. In some examples, the aerosol generating material 11 may comprise tobacco. However, in other examples, the aerosol generating material 11 may consist of tobacco, may consist substantially entirely of tobacco, may comprise tobacco and aerosol generating material other than tobacco, may comprise aerosol generating material other than tobacco, or may be free from tobacco. In some examples, the aerosol generating material 11 may comprise a vapor or aerosol forming agent or a humectant, such as glycerol, propylene glycol, triacetin, or diethylene glycol. In some examples, the aerosol generating material 11 may comprise reconstituted aerosol generating material, such as reconstituted tobacco.

In some examples, the aerosol generating material 11 is substantially cylindrical with a substantially circular cross section and a longitudinal axis. In other examples, the aerosol generating material 11 may have a different cross-sectional shape and/or not be elongate.

The article 10 may also comprise a wrapper (not shown) that is wrapped around the aerosol generating material 11 and the filter arrangement 12 to retain the filter arrangement 12 relative to the aerosol generating material 11. The wrapper may be wrapped around the aerosol generating material 11 and the filter arrangement 12 so that free ends of the wrapper overlap each other. The wrapper may form part of, or all of, a circumferential outer surface of the article 10. The wrapper could be made of any suitable material, such as paper, card, or reconstituted aerosol generating material (e.g. reconstituted tobacco). The paper may be a tipping paper that is known in the art. In other examples, the adhesive may be omitted or the wrapper may take a different from to that described. In some examples, the filter arrangement 12 may be omitted.

The aerosol provision device 100 may comprise a heating zone 110 for receiving at least a portion of the article 10, an outlet 120 through which aerosol is deliverable from the heating zone 110 to a user in use, and heating apparatus 130 for causing heating of the article 10 when the article 10 is at least partially located within the heating zone 110 to thereby generate the aerosol. In some examples, such as that shown in FIG. 1, the aerosol is deliverable from the heating zone 110 to the user through the article 10 itself, rather than through any gap adjacent to the article 10. Nevertheless, in such examples, the aerosol still passes through the outlet 120, albeit while travelling within the article 10.

The aerosol provision device 100 may define at least one air inlet (not shown) that fluidly connects the heating zone 110 with an exterior of the aerosol provision device 100. A user may be able to inhale the volatilized component(s) of the aerosol generating material by drawing the volatilized component(s) from the heating zone 110 via the article 10.

In this example, the heating zone 110 extends along an axis A-A and is sized and shaped to accommodate only a portion of the article 10. In this example, the axis A-A is a central axis of the heating zone 110. Moreover, in this example, the heating zone 110 is elongate and so the axis A-A is a longitudinal axis A-A of the heating zone 110. The article 10 is insertable at least partially into the heating zone 110 via the outlet 120 and protrudes from the heating zone 110 and through the outlet 120 in use. In other examples, the heating zone 110 may be elongate or non-elongate and dimensioned to receive the whole of the article 10. In some such examples, the aerosol provision device 100 may include a mouthpiece that can be arranged to cover the outlet 120 and through which the aerosol can be drawn from the heating zone 110 and the article 10.

In this example, when the article 10 is at least partially located within the heating zone 110, different portions 11a-11e of the aerosol generating material 11 are located at different respective locations 111a-110e in the heating zone 110. In this example, these locations 110a-110e are at different respective axial positions along the axis A-A of the heating zone 110. Moreover, in this example, since the heating zone 110 is elongate, the locations 111-115 can be considered to be at different longitudinally-spaced-apart positions along the length of the heating zone 110. In this example, the article 10 can be considered to comprise five such portions 11a-11e of the aerosol generating material 11 that are located respectively at a first location 111, a second location 112, a third location 113, a fourth location 114 and a fifth location 115.

The heating apparatus 130 may comprise plural heating units 140a-140e, each of which is able to cause heating of a respective one of the portions 11a-11e of the aerosol generating material 11 to a temperature sufficient to aerosolize a component thereof, when the article 10 is at least partially located within the heating zone 110. The plural heating units 140a-140e may be axially-aligned with each other along the axis A-A. Each of the portions 11a-11e of the aerosol generating material 11 heatable in this way may, for example, have a length in the direction of the axis A-A of between 1 mm and 20 mm, such as between 2 mm and 10 mm, between 3 mm and 8 mm, or between 4 mm and 6 mm.

The heating apparatus 130 also may comprise a controller 135 that is configured to cause operation of the heating units 140a-140e to cause the heating of the respective portions 11a-11e of the aerosol generating material 11 in use. In this example, the controller 135 is configured to cause operation of the heating units 140a-140e independently of each other, so that the respective portions 11a-11e of the aerosol generating material 11 can be heated independently. This may be desirable in order to provide progressive heating of the aerosol generating material 11 in use. Moreover, in examples in which the portions 11a-11e of the aerosol generating material 11 have different respective forms or characteristics, such as different tobacco blends and/or different applied or inherent flavors, the ability to independently heat the portions 11a-11e of the aerosol generating material 11 can enable heating of selected portions 11a-11e of the aerosol generating material 11 at different times during a session of use so as to generate aerosol that has predetermined characteristics that are time-dependent.

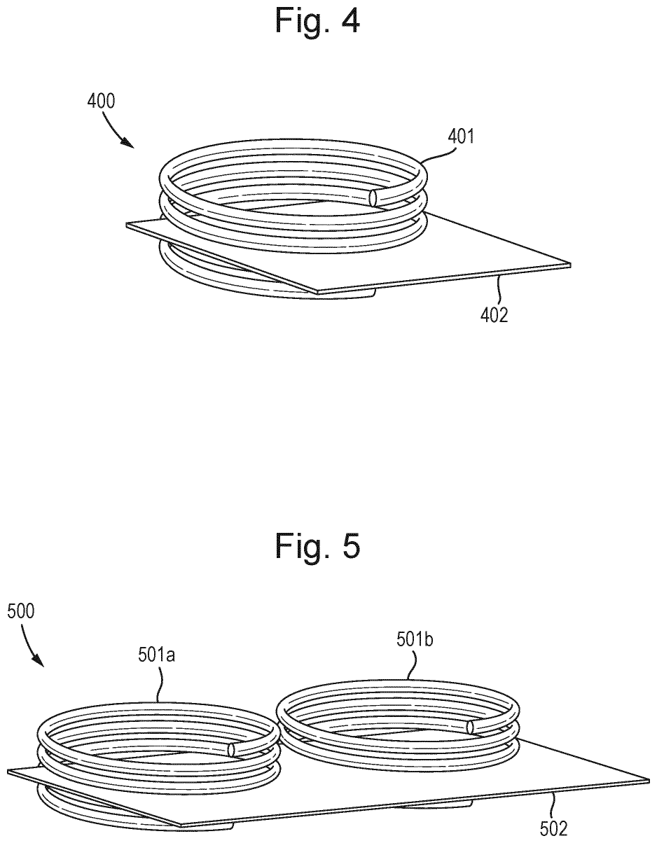

In this example, the heating units 140a-140e comprise respective induction heating units that are configured to generate respective varying magnetic fields, such as alternating magnetic fields. As such, the heating apparatus 130 can be considered to comprise a magnetic field generator, and the controller 135 can be considered to be apparatus that is operable to pass a varying electrical current through inductors of the respective heating units 140a-140e. The inductors of the respective heating units 140a-140e may comprise any one or more of the inductor coils as described below, such as any one or more of the inductor coils 400, 500, 600, 700 arrangements shown in FIGS. 4-7. Moreover, in this example, the aerosol provision device 100 may comprise a susceptor 190 that is configured so as to be heatable by penetration with the varying magnetic fields to thereby cause heating of the heating zone 110 and the article 10 therein in use. That is, portions of the susceptor 190 are heatable by penetration with the respective varying magnetic fields to thereby cause heating of the respective portions 11a-11e of the aerosol generating material 11 at the respective locations 111-115 in the heating zone 110.

In some examples, the susceptor 190 is made of, or comprises, aluminum. However, in other examples, the susceptor 190 may comprise one or more materials selected from the group consisting of: an electrically-conductive material, a magnetic material, and a magnetic electrically-conductive material. In some examples, the susceptor 190 may comprise a metal or a metal alloy. In some examples, the susceptor 190 may comprise one or more materials selected from the group consisting of: aluminum, gold, iron, nickel, cobalt, conductive carbon, graphite, steel, plain-carbon steel, mild steel, stainless steel, ferritic stainless steel, molybdenum, silicon carbide, copper, and bronze. Other material(s) may be used in other examples.

In some examples, such as those in which the susceptor 190 may comprise iron, such as steel (e.g. mild steel or stainless steel) or aluminum, the susceptor 190 may comprise a coating to help avoid corrosion or oxidation of the susceptor 190 in use. Such coating may, for example, comprise nickel plating, gold plating, or a coating of a ceramic or an inert polymer.

In this example, the susceptor 190 is tubular and encircles the heating zone 110. Indeed, in this example, an inner surface of the susceptor 190 partially delimits the heating zone 110. An internal cross-sectional shape of the susceptor 190 may be circular or a different shape, such as elliptical, polygonal or irregular. In other examples, the susceptor 190 may take a different form, such as a non-tubular structure that still partially encircles the heating zone 110, or a protruding structure, such as a rod, pin or blade, that penetrates the heating zone 110. In some examples, the susceptor 190 may be replaced by plural susceptors, each of which is heatable by penetration with a respective one of the varying magnetic fields to thereby cause heating of a respective one of the portions 11a-11e of the aerosol generating material 11. Each of the plural susceptors may be tubular or take one of the other forms discussed herein for the susceptor 190, for example. In still further examples, the aerosol provision device 100 may be free from the susceptor 190, and the article 10 may comprise one or more susceptors that are heatable by penetration with the varying magnetic fields to thereby cause heating of the respective portions 11a-11e of the aerosol generating material 11. Each of the one or more susceptors of the article 10 may take any suitable form, such as a structure (e.g. a metallic foil, such as an aluminum foil) wrapped around or otherwise encircling the aerosol generating material 11, a structure located within the aerosol generating material 11, or a group of particles or other elements mixed with the aerosol generating material 11.

In this example, the heating apparatus 130 may comprise an electrical power source (not shown) and a user interface (not shown) for user-operation of the device. The electrical power source of this example is a rechargeable battery. In other examples, the electrical power source may be other than a rechargeable battery, such as a non-rechargeable battery, a capacitor, a battery-capacitor hybrid, or a connection to a mains electricity supply.

In this example, the controller 135 is electrically connected between the electrical power source and the heating units 140a-140e. In this example, the controller 135 also is electrically connected to the electrical power source. More specifically, in this example, the controller 135 is for controlling the supply of electrical power from the electrical power source to the heating units 140a-140e. In this example, the controller 135 may comprise an integrated circuit (IC), such as an IC on a printed circuit board (PCB). In other examples, the controller 135 may take a different form. The controller 135 is operated in this example by user-operation of the user interface. The user interface may comprise a push-button, a toggle switch, a dial, a touchscreen, or the like. In other examples, the user interface may be remote and connected to the rest of the aerosol provision device 100 wirelessly, such as via Bluetooth.

Further discussion of the form of each of the heating units 140a-140e will be given below with reference to FIGS. 2 and 3. However, what is notable at this stage is that the size or extent of the varying magnetic fields as measured in the direction of the axis A-A is relatively small, so that the portions of the susceptor 190 that are penetrated by the varying magnetic fields in use are correspondingly small. Accordingly, it may be desirable for the susceptor 190 to have a thermal conductivity that is sufficient to increase the proportion of the susceptor 190 that is heated by thermal conduction as a result of the penetration by the varying magnetic fields, so as to correspondingly increase the proportion of the aerosol generating material 11 that is heated by operation of each of the heating units 140a-140e. It has been found that it is desirable to provide the susceptor 190 with a thermal conductivity of at least 10 W/m/K, optionally at least 50 W/m/K, and further optionally at least 100 W/m/K. In this example, the susceptor 190 is made of aluminum and has a thermal conductivity of over 200 W/m/K, such as between 200 and 250 W/m/K, for example approximately 205 W/m/K or 237 W/m/K. As noted above, each of the portions 11a-11e of the aerosol generating material 11 may, for example, have a length in the direction of the axis A-A of between 1 mm and 20 mm, such as between 2 mm and 10 mm, between 3 mm and 8 mm, or between 4 mm and 6 mm.

In this example, the heating apparatus 130 is configured to cause heating of the first portion 11a of the aerosol generating material 11 to a temperature sufficient to aerosolize a component of the first portion 11a of the aerosol generating material 11 before or more quickly than the heating of the second portion 11b of the aerosol generating material 11 during a heating session. More specifically, the controller 135 is configured to cause operation of the first and second heating units 140a,140b to cause the heating of the first portion 11a of the aerosol generating material 11 before or more quickly than the heating of the second portion 11b of the aerosol generating material 11 during the heating session. Accordingly, during the heating session, the position at which heat energy is applied to the aerosol generating material 11 of the article 10 is initially relatively fluidly spaced from the outlet 120 and the user, and then moves towards the outlet 120.

Referring to FIG. 2, there is shown a flow diagram showing an example of a method of heating aerosol generating material during a heating session using an aerosol provision device. The aerosol provision device used in the method 200 may comprise a heating zone for receiving at least a portion of an article comprising aerosol generating material, an outlet through which aerosol is deliverable from the heating zone to a user in use, and heating apparatus for causing heating of the article when the article is at least partially located within the heating zone to thereby generate the aerosol. The aerosol provision device may, for example, be that which is shown in FIG. 1 or any of the suitable variants thereof discussed herein.

The method 200 may comprise the heating apparatus 130 causing, when the article 10 is at least partially located within the heating zone 110, heating 210 of a first portion 11a of the aerosol generating material 11 of the article 10 to a temperature sufficient to aerosolize a component of the first portion 11a of the aerosol generating material 11 before or more quickly than heating 220 of a second portion 11b of the aerosol generating material 11 of the article 10 to a temperature sufficient to aerosolize a component of the second portion 11b of the aerosol generating material 11, wherein the second portion 11b of the aerosol generating material 11 is fluidly located between the first portion 11a of the aerosol generating material 11 and the outlet 120.

It will be understood from the teaching herein that the method 200 could be suitably adapted to comprise the heating apparatus 130 also causing heating of at least one further portion 11b-11e of the aerosol generating material 11 to a temperature sufficient to aerosolize a component of the further portion 11b-11e of the aerosol generating material 11 before or more quickly than the heating of a still further portion 11c-11e of the aerosol generating material 11 that is fluidly closer to the outlet 120, as discussed above.

Referring to FIG. 3, there is shown a flow diagram showing another example of a method of heating aerosol generating material during a heating session using an aerosol provision device. The aerosol provision device used in the method 300 may comprise a heating zone for receiving at least a portion of an article comprising aerosol generating material, an outlet through which aerosol is deliverable from the heating zone to a user in use, and heating apparatus for causing heating of the article when the article is at least partially located within the heating zone to thereby generate the aerosol. The heating apparatus may comprise a first heating unit, a second heating unit, a third heating unit and a controller that is configured to cause operation of the first, second and third heating units. The aerosol provision device may, for example, be that which is shown in FIG. 1 or any of the suitable variants thereof discussed herein.

The method 300 may comprise the controller 135 controlling the first, second and third heating units 140a,140b,140c independently of each other to cause, when the article 10 is at least partially located within the heating zone 110: the first heating unit 140a to heat 310 a first portion 11a of the aerosol generating material 11 of the article 10 to a temperature sufficient to aerosolize a component of the first portion 11a of the aerosol generating material 11 (e.g. before or more quickly than the second portion 11b); the second heating unit 140b to heat 320 a second portion 11b of the aerosol generating material 11 of the article 10 to a temperature sufficient to aerosolize a component of the second portion 11b of the aerosol generating material 11 (e.g. before or more quickly than the third portion 11c); and the third heating unit 140c to heat 330 a third portion 11c of the aerosol generating material 11 of the article 10 to a temperature sufficient to aerosolize a component of the third portion 11c of the aerosol generating material 11, wherein the second portion 11b of the aerosol generating material 11 is fluidly located between the first portion 11a of the aerosol generating material 11 and the outlet 120, and the third portion 11c of the aerosol generating material 11 is fluidly located between the second portion 11b of the aerosol generating material 11 and the outlet 120.

When the aerosol provision device used in the method 300 may comprise sufficient heating units, it will be understood from the teaching herein that the method 300 could be suitably adapted to comprise the heating apparatus 130 also controlling fourth and fifth heating units 140d, 140e independently of each other to cause, when the article 10 is at least partially located within the heating zone 110: the fourth heating unit 140d to heat a fourth portion 11d of the aerosol generating material 11 of the article 10 to a temperature sufficient to aerosolize a component of the fourth portion 11d of the aerosol generating material 11; and the fifth heating unit 140e to heat a fifth portion 11e of the aerosol generating material 11 of the article 10 to a temperature sufficient to aerosolize a component of the fifth portion 11e of the aerosol generating material 11, wherein the fourth portion 11d of the aerosol generating material 11 is fluidly located between the third portion 11c of the aerosol generating material 11 and the outlet 120, and the fifth portion 11e of the aerosol generating material 11 is fluidly located between the fourth portion 11d of the aerosol generating material 11 and the outlet 120.

One of the heating units 140a-140e of the heating apparatus 130 will now be described in more detail with reference to FIGS. 4-15, which disclose various features of one or more inductor coils 400, 500, 600, 700 of the heating unit.

Referring to FIG. 4, there is shown an inductor coil 401 and an article 402, wherein, in use, the article 402 may be interlaced or otherwise located within or between the inductor coil 401.

As shown in FIG. 5, in arrangements, an article 502 may be interlaced with more than one inductor coil 501a,501b simultaneously. The article 402,502 may correspond to the article 10 for use with the aerosol provision device 100 of FIG. 1.

In arrangements, a plurality articles 402,502 may be interlaced or otherwise located within or between at least one of the one or more inductor coils 401. In arrangements, each article of the plurality articles for use with an aerosol provision device is interlaced or otherwise located within or between a respective inductor coil of the plurality of inductor coils.

As shown in FIGS. 4 and 5, the article or the plurality of articles is located within or between the windings of the one or more inductor coils.

In arrangements, the article or the plurality of articles is substantially planar. The article 402 shown in FIG. 4 is substantially square or rectangular whereas the coil 401 is substantially cylindrical. However, in arrangements, the article may have a cross-section which substantially conforms to a cross-section of the inductor coil. For example, so as to conform with the cylindrical coil shown in FIG. 4, the article may be substantially circular or disk-like. It will be understood that the inductor coil may have the form of any of the arrangements disclosed.

In arrangements comprising a plurality of articles, at least one of the plurality articles has a first article cross-section which is different to a second article cross-section of at least one other of the plurality articles, wherein at least one of the first article cross-section and the second article cross-section substantially conforms to an inductor coil cross-section of the one or more inductor coils. In arrangements comprising a plurality of inductor coils, each article of the plurality articles may have an article cross-section which substantially conforms to a respective inductor coil cross-section of the plurality of inductor coils. Each article with a particular article cross-section may be located within or between the windings of an inductor coil with an inductor coil cross-section to which the particular article cross-section substantially conforms.

In arrangements, the article(s) are interlaced or otherwise located within or between the inductor coil(s) such that there are a substantially equal number of turns of each inductor coil above and below the respective interlaced article.

In arrangements, the article or the one or more articles located within or between the windings of the one or more inductor coils may have a complex geometry, such that the article(s) substantially trace or track the windings of the inductor coil(s).

In arrangements, the aerosol provision device 100 may comprise one or more susceptors. In use, the article(s) may be positioned in proximity to one or more of the susceptors. In arrangements, the one or more susceptors are located within or between the windings of the inductor coil(s). The susceptor(s) located within or between the windings of the inductor coil(s) may substantially trace or track the windings of the one or more inductor coils.

In arrangements, the article or the plurality of articles comprise one or more susceptors.

It has been found that, by interlacing or otherwise locating an article in an inductor coil as described, the inductor coil induces a temperature gradient across the article. This may be desirable, more example for tailoring the properties of the aerosol to be generated from the article. For example, aerosol may be generated from an aerosol generating material with a first flavor by using heat from a first portion of the article with a first temperature distribution, and an aerosol with a second flavor may be generated by using heat from a second portion of the article with a second temperature distribution.

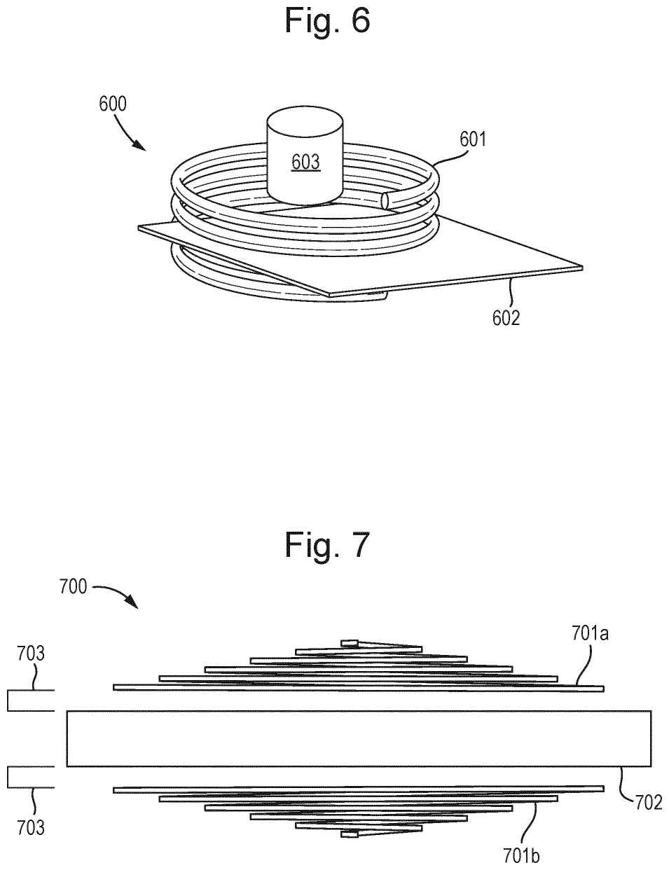

Referring to FIG. 6, the aerosol provision device may comprise an inductor coil arrangement 600 comprising a first inductor coil 601 and a second inductor coil 603, wherein, in use, an article 602 for use with an aerosol provision device is interlaced or otherwise located within or between the first inductor coil 601. The second inductor coil 603 may comprise a central inductor coil 603 which may be positioned radially inwards of the first inductor coil 603. In other arrangements, the central inductor coil 603 may be positioned radially outwards of the first inductor coil 601.

In arrangements, the article 602 is interlaced or otherwise located within or between the first inductor coil 601 such that there are a substantially equal number of turns of the first inductor coil 601 above and below the article 602.

The temperature gradient across the article 602 may be tuned or controlled by using the second inductor coil 603. The second inductor coil 603 may be operated independently from the first inductor coil 601.

Referring to FIG. 7, there is shown a first inductor coil 701a and a second inductor coil 701b wherein, in use, an article 702 is located equidistant 703 between the first and second inductor coils, wherein the article 702 does not penetrate inside either of the first 701a and second 701b inductor coils.

In arrangements, the first 701a and second 701b inductor coils are connected in series. However, in arrangements the first 701a and second 701b inductor coils may not be electrically connected or may be substantially electrically independent or isolated from one another.

The article 702 may have a shape defining a first face profile and a second face profile, wherein, in use, the first face profile faces the first inductor coil 701a and the second face profile faces the second inductor coil 702b.

In arrangements, there may be a device for supplying electrical power to the one or more inductor coils, the device for supplying electrical power configured to allow an oscillating electrical current to flow in the one or more inductor coils. For example, the device for supplying electrical power to the one or more inductor coils may comprise one or more sources of electrical power. In arrangements, the controller 135 of FIG. 1 may comprise the one or more sources of electrical power.

Alternatively, the device for supplying electrical power to the one or more inductor coils may comprise one or more electrical connectors, such that the inductor coils of the respective heating units 140a-140e and the article 10 of FIG. 1 together form a disposable consumable. In this arrangement, in use, the one or more electrical connectors connect to one or more electrical power sources of a non-disposable apparatus, such that electrical power is supplied to the one or more inductor coils through the one or more electrical connectors.

In arrangements comprising a plurality of inductor coils, the device for supplying electrical power to the one or more inductor coils may be configured to supply electrical power independently to the plurality of inductor coils.

It is known that positioning an article comprising one or more susceptors, or other metallic elements, very close to an inductor will increase the mechanical or positional instability of the article. This is because the oscillating magnetic field generated in use by the inductor can induce a force on the susceptor(s) or metallic elements of a high enough magnitude so as to physically move the article. Accordingly, it has been found that providing an aerosol provision device having one or more inductor coils wherein, in use, an article is interlaced or otherwise located within or between at least one of the one or more inductor coils may lead to a mechanical cancellation effect. For example, by interlacing an article 402 within or between the windings of inductor coil 401 as shown in FIG. 4, the article 402 will experience forces induced by the inductor. These forces will be in mutually opposing directions so as to produce a mechanical cancellation effect. In a similar way, it will be understood that an analogous mechanical cancellation effect will arise from positioning an article 702 equidistant between two inductor coils 701a, 701b, as shown in FIG. 7.

It will be appreciated that the one or more inductor coils of the above described arrangements may be of any number of forms such that, in use, an article is interlaced or otherwise located within or between the inductor coil(s).

In arrangements, the at least one of the one or more inductor coils may comprise a planar non-spiral inductor coil. For example, the at least one of the one or more inductor coils comprising a planar non-spiral inductor coil comprises: (i) a substantially square shape; or (ii) a substantially rectangular shape. In arrangements, the aerosol provision device may comprise two or more planar non-spiral inductor coils.

In arrangements, the planar non-spiral inductor coil may comprise a plurality of mandrel loops, the plurality of mandrel loops being arranged in a multiple layer configuration.

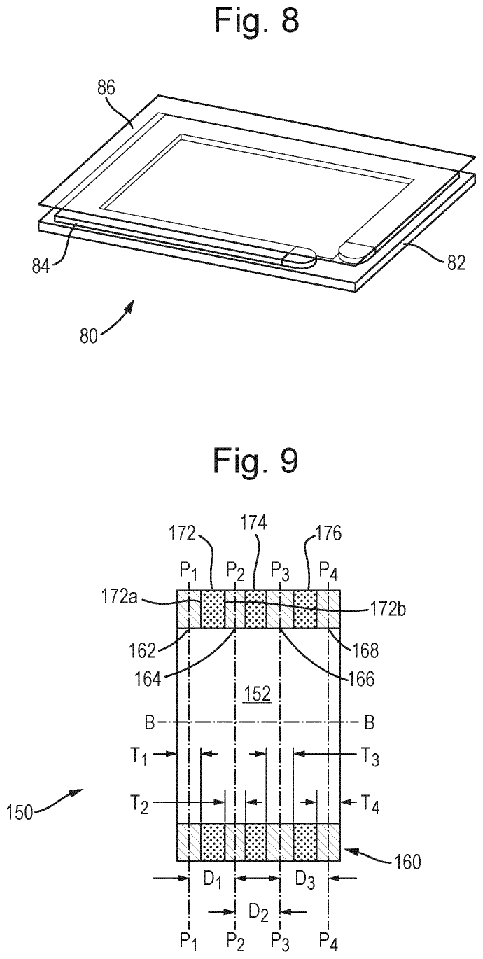

Referring now to FIG. 8, there is shown a schematic perspective view of a planar non-spiral coil 80 which is the form of a mandrel loop 84, formed onto a PCB, according to an arrangement. The coil 80 may be used in a layered arrangement so as to form a layered inductor coil.

The coil 80 may comprise a PCB 82, a planar non-spiral inductor coil disposed onto the PCB 82 in the form an of a mandrel loop 84, and disposed on top of the mandrel loop 84 is an isolator 86. The mandrel loop is formed of electrically-conductive material, such as copper.

Although this arrangement includes a PCB 82, other arrangements are contemplated wherein the mandrel loop 82 is not disposed onto a PCB. Instead only the mandrel loop 84 is present, or only the mandrel loop 84 and isolator 86 are present.

Successive mandrel loops 82 may be arranged to form a coil such that an article may be interlaced or otherwise located within or between the coil.

In the arrangement of FIG. 8, the mandrel loop 84 may comprise only a single turn. However, other arrangements are contemplated where the mandrel loop 84 may comprise more than one turn e.g. two turns, three turns, four turns or more than four turns.

The isolator 86 of this arrangement is in the form of planar plate. The isolator 86 may be made from a non-electrically-conductive material, such as a plastics material, so as to electrically-insulate the mandrel loop 84. In this arrangement, the isolator 86 is made from FR-4, which is a composite material composed of woven fiberglass cloth with an epoxy resin binder that is flame retardant.

In other examples, no respective PCB's 82 or isolators 86 are present, instead a plurality of mandrel loops 84 are arranged in multiple layers. In such examples, the mandrel loops 84 may be electrically insulated from each other in a different way, such as by an air gap. In arrangements, in use, an article may be located within or between such air gaps.

Referring now to examples where a PCB 82 is present, the mandrel loop 84 may be affixed to the PCB 82 in any suitable way. In the arrangement illustrated in FIG. 8, the portion 80 has been formed from printed circuit board (PCB) and so the mandrel loop 84 has been formed by printing the electrically-conductive material onto the respective first and second sides, onto the PCB 82 during manufacture of the PCB 82, and then removing (such as by etching) selective portions of the electrically-conductive material so that patterns of the electrically-conductive material in the form of the mandrel loop remain. Accordingly, mandrel loop 84 is a thin film or coating of electrically-conductive material on the PCB 82.

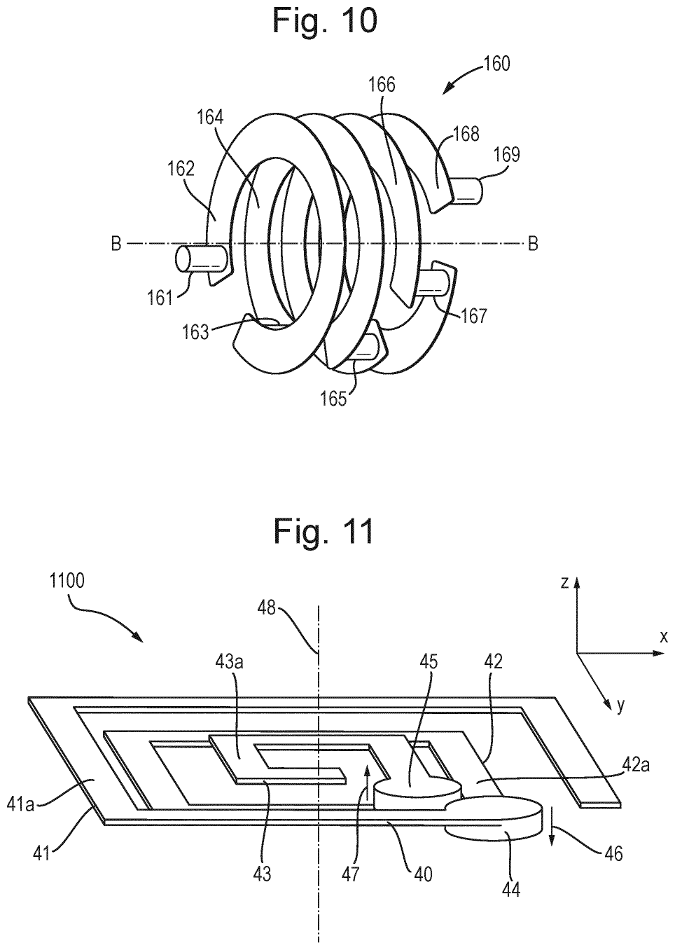

Referring now to FIGS. 9 and 10, these figures respectively show a schematic cross-sectional side view of an inductor coil 150 of the heating unit and a schematic perspective view of an inductor 160.

The inductor coil 150 may comprise an electrically-insulating support 172 and the inductor 160. The support 172 has opposite first and second sides 172a,172b, and parts 162,164 of the inductor 160 are on the respective first and second sides 172a,172b of the support 172.

More specifically, the inductor 160 may comprise an electrically-conductive element 160. The element 160 may comprise an electrically-conductive first portion 162 that is coincident with a first plane P1, and an electrically-conductive second portion 164 that is coincident with a second plane P2 that is spaced from the first plane P1. In this example, the second plane P2 is parallel to the first plane P1, but in other examples this need not be the case. For example, the second plane P2 may be at an angle to the first plane P1, such as an angle of no more than 20 degrees or no more than 10 degrees or no more than 5 degrees. The inductor 160 also may comprise a first electrically-conductive connector 163 that electrically connects the first portion 162 to the second portion 164. The first portion 162 is on the first side 172a of the support 172, and the second portion 164 is on the second side 172b of the support 172. The electrically conductive connector 163 passes through the support 172 from the first side 172a to the second side 172b. The electrically conductive connector 163 may have the structure of plating (e.g. copper plating) on the surface of a through hole provided in the support 172.

The support 172 can be made of any suitable electrically-insulating material(s). In some examples, the support 172 may comprise a matrix (such as an epoxy resin, optionally with added filler such as ceramics) and a reinforcement structure (such as a woven or non-woven material, such as glass fibers or paper).

In some examples, the support 172 may comprise one or more gaps or cavities wherein, in use, an article may be positioned so as to be interlaced or located within or between the inductor coil 150.

The inductor 160 can be made of any suitable electrically-conductive material(s). In some examples, the inductor 160 is made of copper.

In some examples, the inductor coil 150 comprises, or is formed from, a PCB. In such examples, the support 172 is a non-electrically-conductive substrate of the PCB, which may be formed from materials such as FR-4 glass epoxy or cotton paper impregnated with phenolic resin, and the first and second portions 162, 164 of the inductor 160 are tracks on the substrate. This facilitates manufacture of the inductor arrangement 150, and also enables the portions 162, 164 of the element 160 to be thin and closely spaced, as discussed in more detail below.

In this example, the first portion 162 is a first partial annulus 162 and the second portion 164 is a second partial annulus 164. Moreover, in this example, each of the first and second portions 162,164 follows only part of a respective circular path.

Therefore, the first portion or first partial annulus 162 is a first circular arc, and the second portion or second partial annulus 164 is a second circular arc. In other examples, the first and second portions 162,164 may follow a path that is other than circular, such as elliptical, polygonal or irregular. However, matching the shape of the first and second portions 162,164 to the shape (or at least an aspect of the shape, such as outer perimeter) of respective adjacent portions of the susceptor 190 (whether provided in the aerosol provision device 100 or the article 10) helps lead to improved and more consistent magnetic coupling of the inductor 160 and the susceptor 190.

Moreover, in examples in which the first and second portions 162,164 are respective circular arcs, providing that the radii of the circular arcs are equal also can help lead to the generation of a more consistent magnetic field along the length of the inductor 160, and thus more consistent heating of the susceptor 190.

The inductor arrangement 150 has a through-hole 152 that is radially-inward of, and coaxial with, the first and second portions 162, 164 or partial annuli. In the assembled aerosol provision device 100, the susceptor 190 and the heating zone 110 extend through the through-hole 152, so that the portions 162,164 of the element 160 together at least partially encircle the susceptor 190 and the heating zone 110. In examples in which the susceptor 190 is replaced by plural susceptors, each of the plural susceptors may be located so as to extend through the through-holes 152 of one or more inductor arrangements 150 of the respective heating units 140a-140e. In some examples, the or each susceptor does not extend through the through-holes 152, but rather is adjacent (e.g. axially) the associated element 160.

As may best be understood from further consideration of FIG. 10, when viewed in a direction orthogonal to the first plane P1, and thus in the direction of an axis B-B of the inductor 160, the first and second portions 162,164 extend in opposite senses of rotation from the first electrically-conductive connector 163. For example, were one to view the inductor 160 of FIG. 10 in the direction of the axis B-B from left to right as FIG. 10 is drawn, then the first portion 162 of the inductor 160 would extend in an anticlockwise direction from the connector 163, whereas the second portion 164 of the inductor 160 would extend in a clockwise direction from the connector 163.

Moreover, in this example, when viewed in the direction orthogonal to the first plane P1, the first portion 162 or first partial annulus overlaps, albeit only partially, the second portion 164 or second partial annulus. In this example, the first and second portions 162, 164 together define about 1.75 turns about the axis B-B that is orthogonal to the first and second planes P1, P2. In other examples, the number of turns may be other than 1.75, such as another number that is at least 0.9. For example, the number of turns may be between 0.9 and 1.5, or between 1 and 1.25. In other examples, the number of turns may be less than 0.9, although decreasing the number of turns per support 172 may lead to an increase in the axial length of the inductor assembly 150.

Furthermore, when viewed in the direction orthogonal to the first plane P1, the first portion 162 or first partial annulus, as well as the second portion 164 or second partial annulus, at least partially overlaps the first electrically-conductive connector 163. This is facilitated by the inductor arrangement 150 comprising, or being formed from, a PCB (or more generally, a planar substrate layer). In particular, in such examples, the first electrically-conductive connector 163 takes the form of a “via” that extends through the support 172. Even in examples in which the inductor arrangement 150 is not formed from a PCB, the connector 163 still may extend through the support 172. This overlapped arrangement enables the inductor 160 to occupy a relatively small footprint, when viewed in the direction orthogonal to the first plane P1, as compared to a comparative example in which the first and second portions 162, 164 are connected by a connector 163 that is spaced radially outwards of the first and second portions 162, 164. Furthermore, this overlapped arrangement enables the width of the through-hole 152 to be increased, as compared to a comparative example in which the first and second portions 162, 164 are connected by a connector 163 that is spaced radially inwards of the first and second portions 162,164. Nevertheless, in some examples, the connector 163 may be radially-inward or radially-outward of the first and second portions 162, 164. This may be effected by the connector 163 being formed by a “through via” that extends through the support 172. Through vias tend to be cheaper to form than blind vias, as they can be formed after the PCB has been manufactured.

It will be noted that, in this example, the inductor coil 150 may comprise two further supports 174,176, and the element 160 may comprise two further electrically-conductive portions 166,168 that are coincident with two respective spaced-apart planes P3, P4 that are parallel to the first plane P1.

In some arrangements, each of the first, second and third supports 172, 174, 176 may comprise one or more gaps or cavities wherein, in use, an article may be positioned so as to be interlaced or located within or between the inductor coil 150.

In other examples, one or each of the spaced-apart planes P3, P4 may be at an angle to the first plane P1, such as an angle of no more than 20 degrees or no more than 10 degrees or no more than 5 degrees. The second and third electrically-conductive portions 164, 166 are on opposite sides of the second support 174, and are electrically connected by a second electrically-conductive connector 165. The third and fourth electrically-conductive portions 166, 168 are on opposite sides of the third support 176, and are electrically connected by a third electrically-conductive connector 167. The second and third electrically-conductive connectors 165, 167 are rotationally offset from the first electrically-conductive connector 163. In arrangements in which the supports 172,174,176 are formed as a PCB, the connectors 163 and 167 may be formed as “blind vias”, while connector 165 may be formed as a “buried via”.

In this example, the first, second, third and fourth portions or partial annuli 162, 164, 166, 168 together define a total of about 3.6 turns about the axis B-B that is orthogonal to the first and second planes P1, P2. In other examples, the total number of turns may be other than 3.6, such as another number that is between 1 and 10. For example, the total number of turns may be between 1 and 8, or between 1 and 4. Having a relatively small total number of turns is thought to increase the voltage that will be available in the susceptor 190 (whether provided in the aerosol provision device 100 or the article 10) for forcing electrical current along or around the susceptor 190.

It will be noted that the inductor 160 also may comprise first and second terminals 161,169 at opposite ends of the inductor 160. These terminals are for the passage of electrical current through the inductor 160 in use.

In this example, each of the first, second and third supports 172, 174, 176 has a thickness of about 0.85 mm. In some examples, one or more of the supports 172, 174, 176 may have a thickness other than 0.85 mm, such as another thickness lying in the range of 0.2 mm to 2 mm. For example, each of the thicknesses may be between 0.5 mm and 1 mm, or between 0.75 mm and 0.95 mm. In some examples, the thicknesses of the respective supports 172, 174, 176 are equal to each other, or substantially equal to each other. In other examples, one or more of the supports 172, 174, 176 may have a thickness that differs from a thickness of one or more of the other supports 172, 174, 176.

In this example, each of the portions 162, 164, 166, 168 of the inductor 160 has a thickness, measured in a direction orthogonal to the first plane P1, of about 142 micrometers. In some examples, one or more of the portions 162, 164, 166, 168 of the inductor 160 may have a thickness other than 142 micrometers, such as another thickness lying in the range of 10 micrometers to 200 micrometers. For example, each of the thicknesses may be between 25 micrometers and 175 micrometers, or between 100 micrometers and 150 micrometers.

In examples in which the inductor coil 150 is made from a PCB, the thickness of the material of the inductor 160 may be determined by “plating-up” the material on the substrate, prior to construction of the PCB. Some standard circuit boards have a 1 oz layer of electrically-conductive material, such as copper, on the substrate. A 1 oz layer has a thickness of about 38 micrometers. By plating-up to a 4 oz layer, the thickness is increased to about 142 micrometers. Increasing the thickness makes the structure of the inductor arrangement more robust and reduces system losses due to a commensurate reduction in ohmic losses. Increasing the volume of material of the inductor 160 will increase the heat capacity of the inductor 160, reducing the temperature gain for a given input of heat. This may be beneficial, as it can be used to help ensure that the temperature of the inductor 160 itself in use does not get so high as to cause damage to the structure of the inductor arrangement 150. In some examples, the thicknesses of the respective portions 162, 164, 166, 168 of the inductor 160 are equal to each other, or substantially equal to each other. This can lead to a more consistent heating effect being produced by the different portions of the inductor 160. In other examples, one or more of the portions 162, 164, 166, 168 of the inductor 160 may have a thickness that differs from a thickness of one or more of the other portions 162, 164, 166, 168 of the inductor 160. This may be intentional in some examples, so as to provide an increased heating effect produced by certain portion(s) of the inductor 160 as compared to the heating effect produced by other portion(s) of the inductor 160.

In this example, each of the planes P1-P4 is a flat plane, or a substantially flat plane. However, this need not be the case in other examples.

The first and second planes P1, P2 are spaced apart by a distance D1 in the direction of an axis B-B of the inductor 160, as shown in FIG. 5. In this example, the distance D1 between the first and second planes P1, P2 measured in a direction orthogonal to the first and second planes P1, P2 is less than 2 mm, such as less than 1 mm. In other examples, the distance D1 may be between 1 mm and 2 mm, or more than 2 mm, for example.

The combination of the first electrically-conductive connector 163 and the first and second portions 162, 164 of the electrically-conductive element 160 can be considered to be, or to approximate, a helical coil. Indeed, the full inductor 160 can be considered to be, or to approximate, a helical coil.

Given the distances D1, D2, D3 between adjacent pairs of the planes P1, P2, P3, P4, the coil of this example can be considered to have a pitch of less than 2 mm, such as less than 1 mm. In other examples, the pitch may be between 1 mm and 2 mm, or more than 2 mm, for example. Optionally, a distance between each adjacent pair of the portions 162, 164, 166, 168 of the element 160 is equal to, or differs by less than 10% from, a distance between each other adjacent pair of the portions 162, 164, 166, 168 of the element 160. This can lead to the generation of a more consistent magnetic field along the length of the inductor 160, and thus more consistent heating of the susceptor 190.

The smaller the pitch, the greater the ratio of magnetic field strength to mass of susceptor 190 (whether provided in the aerosol provision device 100 or the article 10) to which the energy is being applied. However, this needs to be balanced against the negative effects of the “proximity effect”. In particular, as the pitch is reduced, losses due to the proximity effect increase. Therefore, careful pitch selection is required to reduce the losses in the inductor 160 while increasing the energy available for heating the susceptor 190. It has been found that, in some examples, when the inductors 160 and the controller 135 are suitably configured, they cause the generation of a magnetic field having a magnetic flux density of at least 0.01 Tesla. In some examples, the magnetic flux density is at least 0.1 Tesla.

Relatively small pitches are enabled through the manufacture of the inductor coil 150 from a PCB. Given the present teaching, the skilled person would be able to conceive of other ways of manufacturing induction coils with a similarly small pitch. However, manufacture of the inductor coil 150 from a PCB is likely also to be cheaper than some other ways of manufacturing induction coils, such as by winding LITZ® wire.

While the inductor coil 150 of the example shown in the FIGS. 9-10 has three supports 172, 174, 176 and an inductor 160 comprising four portions 162, 164, 166, 168, this need not be the case in other examples. In some examples, the inductor 160 may have more or fewer than four portions, such as only three portions 162, 164, 166 or only two portions 162, 164. In some examples, the inductor arrangement 150 may have more or fewer than three supports, such as only two supports 172, 174 or only one support 172. Indeed, in some examples, the number of supports in the inductor coil 150 may be only one, and the number of portions of the inductor 160 may be only two, and those two portions 162, 164 of the inductor 160 would be on opposite sides of the single support 172. It will be understood that the number of electrically-conductive connectors 163, 165, 167 would have to be correspondingly adjusted depending on the number of two portions 162, 164, 166, 168 present in the inductor 160. In some examples, the inductor 160 may be provided without any supports between the portions 162, 164, 166, 168 of the inductor 160. In such examples, it is desirable for the inductor 160 to be of sufficient strength to be self-supporting.

Referring to FIG. 11, it will be understood that the inductor coil of the above arrangements may be a layered inductor arrangement 1100. In this example, the layered inductor arrangement 1100 includes three layers, namely: a first layer 41; a second layer 42; and a third layer 43. The first layer 41 may comprise an electrically-conductive first portion 41a, the second layer 42 may comprise an electrically-conductive second portion 42a, and the third layer 43 may comprise an electrically-conductive third portion 43a. The second layer 42 may be spaced from the first layer 41 along a first direction given by the arrow 46 by a first spacing. The third layer 43 may be spaced from the second layer 42 along a second direction given by the arrow 47 by a second spacing.

Still referring to FIG. 11, the layered inductor arrangement 1100 may form a single electrically-conductive element. For example, the layered inductor arrangement 1100 may comprise a first electrically-conductive connector 44 that electrically connects the first portion 41a to the second portion 42a, and a second electrically-conductive connector 45 that electrically connects the second portion 42a to the third portion 43a. In the example of FIG. 11, the first layer 41 is coincident with a first plane, the second layer 42 is coincident with a second plane, and the third layer 43 is coincident with a first plane.

The first, second, and third planes are all depicted as flat parallel planes, for example planes which are parallel to the XY-plane. However, in arrangements, not all of the planes need be flat planes. For example, one of the three planes may be a flat plane, and the remaining planes may be non-flat planes. In arrangements, all of the planes may be non-flat planes. A non-flat plane may be: a curvilinear plane; a plane defined by a surface of revolution; a plane comprising a discontinuity; or combinations thereof. A plane comprising a discontinuity may be a plane having a first portion which is flat or described by a continuous function, and a second portion connected to the first portion such that the first portion is discontinuous with respect to the second portion. For example, a non-flat plane may comprise two flat planes connected together at an angle so as to form an elongated V-shape.

In FIG. 11, the first, second, and third planes are parallel flat planes. Accordingly, the first direction 46 and the second direction 47 are perpendicular to the planes, and are directed in mutually opposing directions. In this way, the layered inductor arrangement may comprise a staggered structure formed from the first 41a, second 42a, and third 43a portions. For example, successive portions are spaced from each such that successive portions are staggered with respect to the z-direction. In the arrangement of FIG. 11, the first spacing between the first 41 and second 42 layers and the second spacing between the second 42 and third 43 layers have equal lengths. In this way, the first layer 41 and third layer 43 are coincident with the same plane such that the third portion 43a of the third layer 43 is positioned radially inwards or inside of the first portion 41a of the first layer 41.

It will be understood that the first layer 41 and the third layer 43 may be different regions of the same layer. In arrangements where the first 41 and third 43 layers are different regions of the same layer, inter-portion regions between the first 41a and third 43a portions may comprise: a non-electrically-conductive material as discussed below; or an insulating gas such as air. It is contemplated that the layered inductor arrangement 150 may be fabricated by layering the in-plane first 41 and third 43 layers simultaneously on-top of the second layer 42. In arrangements, fabrication techniques comprise: PCB fabrication techniques, laser direct structuring; laser active plating; and/or sinter ceramics.

In other arrangements, the first spacing and the second spacing have different lengths.

In some arrangements, a staggered structure may be formed from the first, second, and third portions of any of the aforementioned arrangements, wherein the second direction 47 may be at angle other than 180 degrees relative to the first direction. In this way, the layered inductor arrangement may comprise any number of complex staggered geometries.

In the arrangement of FIG. 11, each of the first 41a, second 42a, and third 43a portions trace a non-spiral shape, wherein the non-spiral is a square or rectangular non-spiral. Each non-spiral may comprise almost one complete turn. For example, each portion may individually comprise a planar non-spiral coil which is in the form of a mandrel loop.

In arrangements, any number of different shapes are contemplated for the electrically-conductive portions.

In arrangements, any one of the electrically-conductive portions may define a partial turn, wherein the partial turn may be less than one full turn or greater than one full turn. Each partial turn of each portion may be defined as a turn about the same axis, such as axis 48 in FIG. 11. Alternatively, each portion may trace a partial turn about a point on each respective plane, wherein the points on each respective plane do not lie on a shared axis. For example, two of the portions may trace respective turns about a shared axis, whereas the other portion may trace a turn about a point which does not lie on the shared axis.

In the arrangement of FIG. 11, neither of the first 41 or third 43 portion overlap the second portion 42 when viewed from a perspective face-on to the layers, that is, viewed from along the z-axis. However, in arrangements, at least one of the first portion and the third portion at least partially overlaps the second portion when viewed from a perspective face-on to the layers. It will be understood that this increases track density with respect to the XY-plane. In this way, the magnetic field able to be generated by the layered inductor arrangement can have a greater field strength as compared to an inductor arrangement comprising only a single flat inductor or single flat spiral. This is because the track widths of the electrically-conducting portion are limited/distances between electrically-conducting portions or tracks are limited because of mechanical/electrical restraints. In this way, staggering the inductor arrangement in the z-direction or out-of-plane direction effectively increases the track density while avoiding the aforementioned limitations. However, it will be appreciated that layered inductor arrangement 1100 will still benefit from being conveniently sized so as to facilitate various different positioning of components within or between the aerosol provision aerosol provision device 100.

In arrangements, in use, an article may be located or interlaced within or between successive layers of the layered inductor arrangement 1100.

The inductor arrangement 1100 may comprise support 40, such as that provided by a PCB. One or more layers may be supported by one or more supports by being disposed on the one or more supports, or embedded in (either partially or fully) the one or more supports. In the arrangement of FIG. 11, the third layer 43 is shown disposed on the support 40, with the other two layers being self-supported by the first and second electrically-conductive connectors. However, other arrangements are contemplated wherein more of the layers are supported by further supports, such as all the layers each being disposed or embedded on a respective support. Alternatively, only some of the layers may be supported such that the inductor arrangement may comprise one or more supports. For example, each of the supported layers may be disposed on or embedded in a respective support, or a single support may be configured such that two or more layers are supported by the same single support, or combinations thereof. In yet other arrangements, the inductor arrangement 150 may comprise no support(s). It will be understood that the one or more supports can be made of any suitable electrically-insulating material(s). In some examples, the support 140 may comprise a matrix (such as an epoxy resin, optionally with added filler such as ceramics) and a reinforcement structure (such as a woven or non-woven material, such as glass fibers or paper).

The electrically-conductive portions 41a-43a and electrically-conductive connectors 44,45 can be made of any suitable electrically-conductive material(s). In some examples, the portions 41a-43a and connectors 44,45 are made of copper. In arrangements wherein the inductor arrangement 150 may comprise one or more supports 40, the electrically-conductive connectors 44,45 may take the form of a “via” that extends through the one or more supports 40. Even in examples in which the inductor arrangement 1100 is not formed from a PCB, the connectors 44,45 still may extend through the one or more supports 40.

In arrangements, one or more tracks comprising magnetic material may be located within or between the staggered structure. The magnetic material may be ferromagnetic or ferrimagnetic. For example, the magnetic material may be a hard ferromagnetic material, a hard ferrimagnetic material, a soft ferromagnetic material, or a soft ferrimagnetic material, wherein hard or soft corresponds to high or low coercive fields, respectively. The magnetic material may for example comprise ferrite or magnetite.

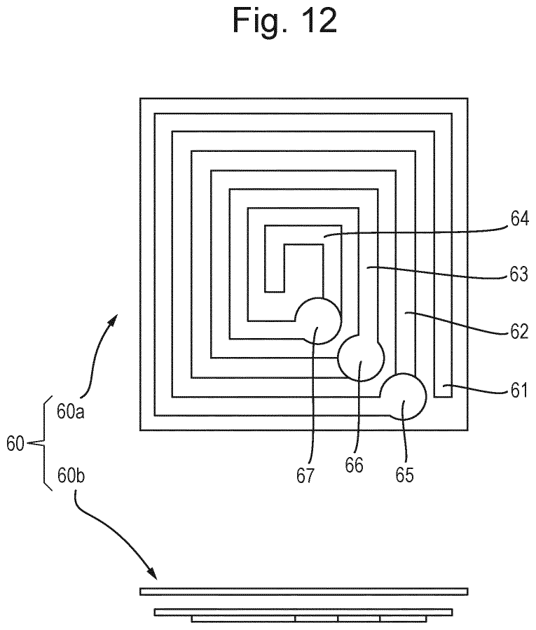

It will be understood that the above described layered inductor arrangement may be formed from an electrically-conductive element comprising any number of further spaced-apart layers comprising respective electrically-conductive portions. In arrangements, the layered inductor arrangement may comprise between four and six layers, or between seven and nine layers, or greater than ten layers. For example, FIG. 12 shows a layered inductor arrangement 60 comprising four layers 61-64 from a face-on perspective 60a and from a side-on perspective 60b. In FIG. 12, the respective electrically-conductive connectors 65-66 are not shown in the side-on perspective 60b for reasons of clarity. In the arrangement of FIG. 12, the spacings between successive layers are not equal, such that at least three of the layers are each coincident with a different plane, as can be seen from the side-on perspective 60b. Accordingly, the extent to which successive layers of the layered inductor arrangement are staggered and spaced with respect to one another provides an additional parameter by which the form of an induced magnetic field induced by the layered inductor arrangement may be tuned. As a consequence, the heat concentration induced by the magnetic field in a nearby susceptor (such as susceptor 190 in FIG. 1) can be selectively tuned by suitable design of the staggered structure of the layered inductor arrangement 1100, 60.

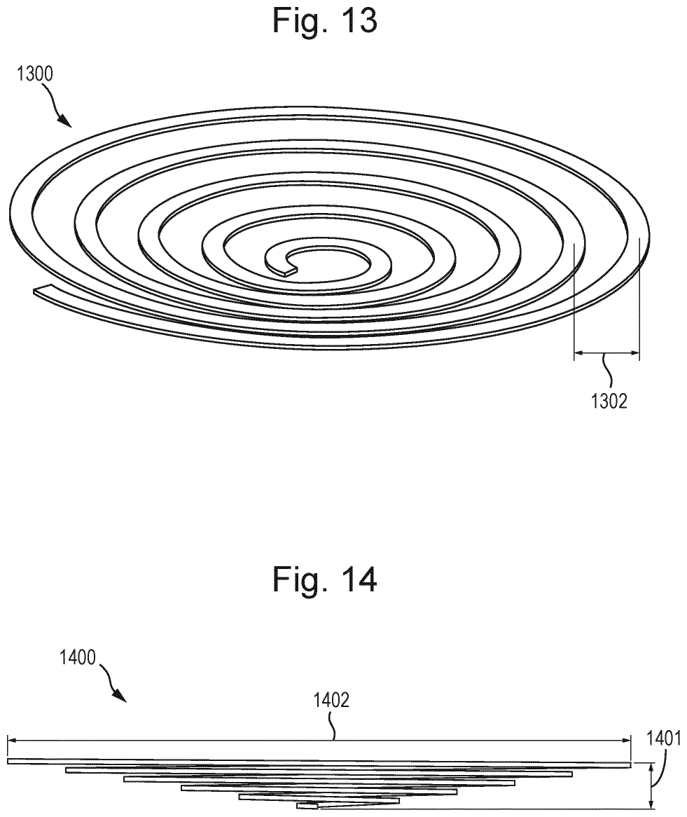

As shown in FIG. 13, one or more of the inductor coils of the above described arrangements may comprise a conically shaped inductor coil.

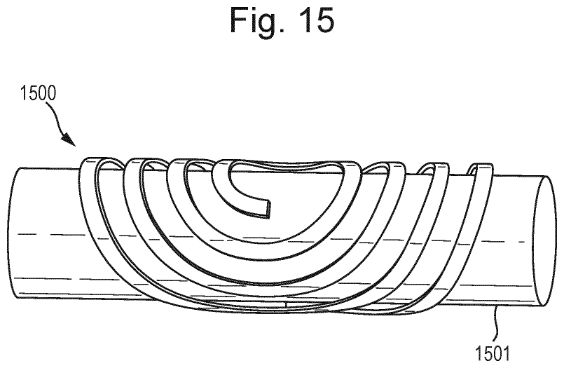

Referring to FIGS. 13 and 14, there is shown a schematic of a perspective view and a side-on view, respectively, of an example of a conically shaped induction coil 1300, 1400 according to an arrangement.

The induction coil 1300, 1400 shown in FIGS. 13 and 14 may comprise a conical spiral or conical helix of electrically-conductive material, such as copper. As shown in FIG. 14, the conically shaped inductor coil has a conical height 1401 and a conical base or base width 1402. In arrangements, the conically shaped inductor coil may comprise a shorter conical height relative to a width of the conical base. In other words, the height 1401 of the coil may be shorter than the width 1402 of the coil.

An inductor coil with no conical height may be referred to as a flat or planar inductor coil, such as having a flat spiral shape. Compared to a flat or planar inductor coil, the conically shaped inductor coils 701a-b, 1300, 1400 and as shown and described with relation to FIGS. 7, 13 and 14, and which relate to various arrangements may advantageously facilitate electrical connections to a power supply in a compact manner, wherein the power supply may be configured to provide an oscillating current to the conically shaped inductor coil. It will be appreciated that subjecting an inductor coil to an oscillating current may induce heating within or between the inductor coil by means of resistive heating. Therefore, the conically shaped inductor coils 701a-b, 1300, 1400 and may be configured to better dissipate heat in a controlled manner as compared to a flat inductor coil, as heat dissipated within or between the plane of the flat inductor coil comprising a plurality of turns will be greater due to the plurality of in-plane turns, whereas the turns of the conically shaped inductor coils do not all reside within or between the same plane.

Referring to again to FIG. 7, there is shown a schematic side-on view of two conically shaped inductor coils 701a-b positioned relative to an article 702. The article 702 shown in FIG. 7 has a substantially rectangular cuboid shape. The article 702 may have a thickness substantially smaller than a width. The article 702 may be substantially planar. However, in other arrangements the article 702 may have a different shape or configuration as described below.

The two conically shaped inductor coils 701a-b are shown in FIG. 7 with their respective conical bases facing the article 702, with the conical bases orientated to be parallel to a planar face of the article 702. However, in arrangements, the conical bases of the conically shaped inductor coils 701a-b may be facing away from the article 702. In arrangements, the conical bases may be orientated so as to not be parallel to a planar face of the article 702, that is, they may be orientated at an angle to the article 702.

Although only a single article 702 is shown in FIG. 7, in arrangements are contemplated wherein a plurality of articles 702 may be provided. Similarly, although two conically shaped inductor coils 701a-b are shown in FIG. 7, other arrangements are contemplated wherein only a single conically shaped inductor coil is provided. According another arrangement more than two conically shaped inductor coils 701a-b may be provided.

Accordingly, in arrangements, there may be provided one or more conically shaped inductor coils and one or more articles, wherein the number of conically shaped inductor coils need not be the same as the number of articles. For example, multiple coils and/or susceptors may be provided along the length and/or width of a consumable. In particular, multiple coils and/or susceptors may be provided along the length and/or width of a flat consumable.

Furthermore, in arrangements, a first conically shaped inductor coil and a first susceptor may be orientated with respect to each other in a first orientation, and a second conically shaped inductor coil and a second susceptor may be orientated with respect to each other in a second orientation.

In arrangements, the first and second orientations may be the same. Alternatively, the first and second orientations may be different. In yet other arrangements, some orientations between some conically shaped inductor coils and some susceptors may be the same whereas other orientations between other conically shaped inductor coils and other susceptors may be different.

The conically shaped inductor coils 701a-b, 1300, 1400, according to various arrangements as shown in FIGS. 7, 13 and 14 comprise a short conical height relative to a width of the conical base.

A device (not shown) may be provided for passing a varying electrical current through the conically shaped inductor coils 701a-b, 1300, 1400 such that a varying magnetic field is generated. In arrangements comprising a plurality of conically shaped inductor coils, the device may be configured to be operable to respectively generate a varying magnetic field from each one of the conically shaped inductor coils, wherein each of the varying magnetic fields are generated independently of each other. The varying magnetic fields may induce heating in one or more susceptors. The low conical height-to-width ratio of the conically shaped inductor coils 701a-b, 1300, 1400, may generate a stronger inductive coupling between a conically shaped inductor coil 701a-b, 1300, 1400 and an article 702. For example, this may be because the article 702 may have a shape which conforms to the shape of a conically shaped inductor coil 701a-b, 1300, 1400. In arrangements, the shape of the article 702 conforms to the shape of the conically shaped inductor coil 701a-b, 1300, 1400 because the article 702 may comprise a substantially planar surface parallel to and facing the conical base of the conically shaped inductor coil 701a-b, 1300, 1400.

Similarly, in arrangements, the low conical height-to-width ratio of the conically shaped inductor coils 701a-b, 1300, 1400 may also induce a substantially uniform inductive coupling across a relatively large portion of the article 702 or across substantially the entirety of the article 702.

The conically shaped induction coil 1300, 1400 as shown in FIGS. 13 and 14 has a constant pitch 1302, wherein the pitch 1302 is the distance separating a point on the coil from an adjacent point after one turn of the coil. However, according to other arrangements, the conically shaped inductor coil may have a varying pitch. In arrangements, the variation of the pitch may be configured such that the conically shaped induction coil may induce a substantially uniform inductive coupling across a large portion of the article 702 or across substantially the entirety of the article 702. In arrangements, the variation of the pitch may be configured such that the conically shaped induction coil may induce a stronger coupling across a first portion of the susceptor compared with a second portion of the susceptor.

The induction coil 1300, 1400 shown in FIGS. 13 and 14 can be described as having a circular spiral projected shape, wherein a projected shape is the shape formed from projecting the shape of the inductor coil onto the conical base. However, in other arrangements, the conically shaped inductor coil may have a projected shape of a square or rectangular spiral; a trapezoidal spiral; a triangular spiral; or any other two dimensional shape.

The projected shape may be chosen so as to allow positioning of other components within or between the device in a small and compact manner. In arrangements, the projected shape may have one or more rectilinear sides. In arrangements, the projected shape may have one or more curvilinear sides. In other arrangements, the projected shape may have a mixture or rectilinear and curvilinear sides. In some arrangements, the projected shape of the conically shaped inductor coil conforms with, or substantially conforms with, the shape of a susceptor.

The induction coil 1300, 1400 shown in FIGS. 13 and 14 can be described as having a conical axis, wherein the conically shaped inductor coil may comprise a cone apex, and the conical axis is a straight line passing through the apex and the center of the conical base. The induction coil 1300, 1400 shown in FIGS. 13 and 14 has a conical axis which is perpendicular to the conical base. In other arrangements, the conical axis may be at an angle other than 90 degrees to the conical base.

Other arrangements are contemplated wherein the induction coil 1300, 1400 does not have a conical axis as the line about which the coil turns may be curved or otherwise non-linear.

The induction coil 1300, 1400 shown in FIGS. 13 and 14 has a coil of conducting material with a thickness or cross-sectional area which is uniform along the coil. However, in other arrangements, the thickness or cross-sectional area may vary along the coil. In arrangements, the variation of thickness or cross-sectional area may be configured such that the conically shaped induction coil may induce a substantially uniform inductive coupling across a large portion of the article 702 or across substantially the entirety of the article 702. In arrangements, the variation of thickness or cross-sectional area may be configured such that the conically shaped induction coil may induce a stronger coupling across a first portion of the susceptor compared with a second portion of the susceptor.

In arrangements, the conducting material may comprise a composition which varies along the coil. For example, in some arrangements, a first portion of the conically shaped inductor coil may be formed from a first conducting material and a second portion of the conically shaped inductor coil may be formed from a second conducting material. The material properties of the first and second portions of the conically shaped inductor coil may be different. In arrangements these material properties may comprise electrical properties such as resistivity or conductivity. In arrangements, the variation of the composition of the conducting material along the conically shaped inductor coil may be configured such that the conically shaped induction coil may induce a substantially uniform inductive coupling across a large portion of the article 702 or across substantially the entirety of the article 702. In arrangements, the variation of the composition of the conducting material along the conically shaped inductor coil may be configured such that the conically shaped induction coil may induce a stronger coupling across a first portion of the susceptor compared with a second portion of the susceptor.

In arrangements, the conically shaped inductor coil may be a conically shaped bifilar inductor coil, wherein the bifilar coil may comprise two or more closely spaced parallel windings. Providing a conically shaped bifilar inductor coil may increase inductive coupling between the coil and a susceptor, thereby increasing the efficiency of the system. For example, in arrangements, the conically shaped bifilar inductor coil may increase the surface area from which varying magnetic fields may be generated. In arrangements, a conically shaped bifilar inductor coil may also, or alternatively, reduce the self-induction of the inductor coil.

Another arrangement will now be described in more detail with reference to FIG. 15. According to this arrangement an inductor coil 1500 is formed around a curved plane or three dimensional surface, such that an initially flat inductor coil may be wrapped around or into a curved plane. For example, in arrangements, the curved plane or three dimensional surface may comprise a cylinder. However, it is to be understood that the inductor coil 1500 can be wrapped around other curved planes or three dimensional surfaces. For example, the inductor coil 1500 may be folded around the corner of a cuboid shape.

FIG. 15 shows an inductor coil 1500 which is a flat or planar inductor coil formed around or wrapped around a cylinder. However, in other arrangements, the inductor coil 1500 may be a conically shaped inductor coil 701a-b, 1300, 1400 as discussed above wherein the inductor coil has a non-zero conical height. For example, a conically shaped inductor coil 701a-b, 1300, 1400 may be formed around a curved plane or three dimensional surface by forming the conical base of the conically shaped inductor coil 701a-b, 1300, 1400 around the curved plane or three dimensional surface.

In arrangements, the inductor coil 1500 or conically shaped inductor coil 701a-b, 1300, 1400 may be provided on or embedded in a support. Arrangements are contemplated wherein one or more inductor coils 1500 and/or one or more conically shaped inductor coils 701a-b, 1300, 1400 may be embedded into or form a mesh with a substrate or support 1501. The substrate, mesh or support may be made from a non-electrically-conductive material, such as a plastics material, so as to electrically-insulate the one or more inductor coils 1500 or the one or more conically shaped inductor coils 701a-b, 1300, 1400 from other electronic components, or other inductor coils or conically shaped inductor coils 701a-b, 1300, 1400. In an arrangement, the support or substrate may be made from FR-4, which is a composite material composed of woven fiberglass cloth with an epoxy resin binder that is flame retardant. The one or more inductor coils 1500 and/or one or more conically shaped inductor coils 701a-b, 1300, 1400 may be affixed to the support, substrate or mesh in any suitable way. For example, the one or more conically shaped inductor coils 701a-b, 1300, 1400 and/or one or more inductor coils 1500 may be formed from printed circuit board (PCB), and may have been formed by printing the electrically-conductive material onto the support during manufacture of the PCB, and then removing (such as by etching) selective portions of the electrically-conductive material so that patterns of the electrically-conductive material in the form the inductor coil 1500 or conically shaped inductor coil 701a-b, 1300, 1400 remain on the support, substrate or mesh. In some arrangements, the one or more inductor coils 1500 and/or one or more conically shaped inductor coils 701a-b, 1300, 1400 may comprise a thin film or coating of electrically-conductive material on the support.

It should be understood that arrangements are contemplated wherein a mixture of conically shaped inductor coils 701a-b, 1300, 1400 and planar inductor coils 1500 may be provided.

Referring again to FIG. 15, the one or more inductor coils 1500 may be wrapped into a cylindrical form and embedded in a substrate. In arrangements, the wrapped planar coil 1500 may be configured to retain its structure in the substrate. In arrangements, the substrate may comprise a resin.

In some arrangements, the support may be formed other than a layer of a PCB. For example, the layer may be a layer or sheet of material such as resin or adhesive, which may have dried, cured or solidified.

In some arrangements, the article 10 is a consumable article or an article for use with an aerosol provision device. Once all, or substantially all, of the volatilizable component(s) of the aerosol generating material 11 in the article 10 has/have been spent, the user may remove the article 10 from the heating zone 110 of the aerosol provision device 100 and dispose of the article 10. The user may subsequently re-use the aerosol provision device 100 with another of the articles 10. However, in other respective arrangements, the article 10 may be non-consumable relative to the heating apparatus 130. That is, heating apparatus 130 and the article 2 may be disposed of together once the volatilizable component(s) of the aerosol generating material 11 has/have been spent.

In some arrangements, the article 10 is sold, supplied or otherwise provided separately from the aerosol provision device 100 with which the article 10 is usable. However, in some arrangements, the aerosol provision device 100 and one or more of the articles 10 may be provided together as a system, such as a kit or an assembly, possibly with additional components, such as cleaning utensils.

The aerosol provision device, aerosol generating system and the inductor coil find particular utility when generating aerosol from a substantially flat consumable.

The substantially flat consumable may be provided in either an array or a circular format. Other arrangements are also contemplated.

In some arrangements, e.g. wherein the substantially flat consumable is provided in the form of an array, multiple heating regions may be provided. For example, according to an arrangement one heating region may be provided per portion, pixel or portion of the consumable.

In other arrangements, the substantially flat consumable may be rotated such that a segment of the consumable is heated by a similar shaped heater. According to this arrangement a single heating region may be provided.

In particular, the inductor arrangement according to various arrangements may be provided as part of an aerosol provision device which is arranged to heat-not-burn a consumable as part of a non-combustible aerosol provision system. In particular, the consumable may comprise a plurality of discrete portions of aerosol-generating material.

The consumable may comprise a support on which the aerosol-generating material is provided. The support functions as a support on which the aerosol-generating material forms, easing manufacture. The support may provide tensile strength to the aerosol-generating material, easing handling. In some cases, the plurality of discrete portions of aerosol-generating material are deposited on such a support. In some cases, the plurality of discrete portions of is deposited on such a support. In some cases, the discrete portions of aerosol-generating material are deposited on such a support such that each discrete portion may be heated and aerosolized separately. In an exemplary arrangement the consumable may comprise a plurality of discrete portions of aerosol-generating material, the discrete portions provided on a support and each of the discrete portions comprising less than 15 mg of water.

Suitably, the discrete portions of aerosol-generating material are provided on the support such that each discrete portion may be heated and aerosolized separately. It has been found that a consumable having such a conformation allows a consistent aerosol to be delivered to the user with each puff.

In some cases, the support may be formed from materials selected from metal foil, paper, carbon paper, greaseproof paper, ceramic, carbon allotropes such as graphite and graphene, plastic, cardboard, wood or combinations thereof. In some cases, the support may comprise or consist of a tobacco material, such as a sheet of reconstituted tobacco. In some cases, the support may be formed from materials selected from metal foil, paper, cardboard, wood or combinations thereof. In some cases, the support itself be a laminate structure comprising layers of materials selected from the preceding lists.

In some cases, the support may be non-magnetic. In some cases, the support may be magnetic.

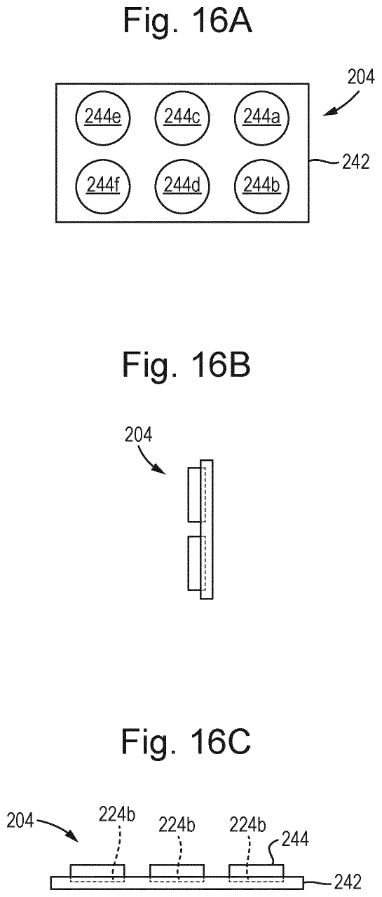

Reference is made to FIGS. 16A-16C. According to an arrangement a consumable or aerosol generating article 204 for use with an aerosol provision device may be provided wherein the aerosol generating article 204 comprises a planar aerosol generating article 204. The planar aerosol generating article 204 may comprise a carrier component 242, one or more susceptor elements 224b and one or more portions of aerosol generating material 244a-f as shown and described in more detail with reference to FIGS. 16A-16C.

FIG. 16A shows a top-down view of an aerosol generating article 204 according to an arrangement, FIG. 16B shows an end-on view along the longitudinal (length) axis of the aerosol generating article 204 according to an arrangement and FIG. 16C shows a side-on view along the width axis of the aerosol generating article 204 according to an arrangement.

The one or more susceptor elements 224b may be formed from aluminum foil, although it should be appreciated that other metallic and/or electrically conductive materials may be used in other implementations. As seen in FIG. 16C, the carrier component 242 may comprise a number of susceptor elements 224b which correspond in size and location to the discrete portions of aerosol generating material 244a-f disposed on the surface of the carrier component 242. That is, the susceptor elements 224b may have a similar width and length to the discrete portions of aerosol generating material 244a-f.

The susceptor elements 224b are shown embedded in the carrier component 242. However, in other arrangements, the susceptor elements 224b may be placed or located on the surface of the carrier component 242. According to another arrangement a susceptor may be provided as a single layer substantially covering the carrier component 244. According to an arrangement the aerosol generating article 204 may comprise a substrate or support layer, a single layer of aluminum foil which acts as a susceptor and one or more regions of aerosol generating material 244 deposited upon the aluminum foil susceptor layer.

According to an arrangement an array of induction heating coils may be provided to energize the discrete portions of aerosol generating material 244. However, according to other arrangements a single induction coil may be provided and the aerosol generating article 204 may be configured to move relative to the single induction coil. Accordingly, there may be fewer induction coils than discrete portions of aerosol generating material 244 provided on the carrier component 242 of the aerosol generating article 204, such that relative movement of the aerosol generating article 204 and induction coil(s) is required in order to be able to individually energize each of the discrete portions of aerosol generating material 244.

Alternatively, a single induction coil may be provided and the aerosol generating article 204 may be rotated relative to the single induction coil.

Although the above has described implementations where discrete, spatially distinct portions of aerosol generating material 244 are deposited on a carrier component 242, it should be appreciated that in other implementations the aerosol generating material 244 may not be provided in discrete, spatially distinct portions but instead be provided as a continuous sheet, film or layer of aerosol generating material 244. In these implementations, certain regions of the sheet of aerosol generating material 244 may be selectively heated to generate aerosol in broadly the same manner as described above. In particular, a region (corresponding to a portion of aerosol generating material) may be defined on the continuous sheet of aerosol generating material 244 based on the dimensions of the one or more inductive heating elements.

According to various arrangements the aerosol generating article 204 may comprise a disc shaped or circular consumable.

In order to address various issues and advance the art, the entirety of this disclosure shows by way of illustration and example various arrangements in which that which is claimed may be practiced and which provide for superior heating elements for use with apparatus for heating aerosolizable material, methods of forming a heating element for use with apparatus for heating aerosolizable material to volatilize at least one component of the aerosolizable material, and systems comprising apparatus for heating aerosolizable material to volatilize at least one component of the aerosolizable material and a heating element heatable by such apparatus. The advantages and features of the disclosure are of a representative sample of arrangements only, and are not exhaustive and/or exclusive. They are presented only to assist in understanding and teach the claimed and otherwise disclosed features. It is to be understood that advantages, arrangements, examples, functions, features, structures and/or other aspects of the disclosure are not to be considered limitations on the disclosure as defined by the claims or limitations on equivalents to the claims, and that other arrangements may be utilized and modifications may be made without departing from the scope and/or spirit of the disclosure. Various arrangements may suitably comprise, consist of, or consist in essence of, various combinations of the disclosed elements, components, features, parts, steps, means, etc. The disclosure may include other inventions not presently claimed, but which may be claimed in future.

1. An aerosol provision device comprising:
an aerosol generator comprising one or more inductor coils;
wherein, in use, an article for use with the aerosol provision device is interlaced or otherwise located within or between at least one of the one or more inductor coils or windings of the one or more inductor coils.

2. The aerosol provision device as claimed in claim 1, wherein the aerosol provision device comprises a first inductor coil and a second inductor coil, wherein, in use, the article for use with the aerosol provision device is interlaced or otherwise located within or between the first inductor coil, and wherein the second inductor coil comprises a central inductor coil positioned radially inwards or outwards of the first inductor coil.

3. The aerosol provision device as claimed in claim 1, wherein the one or more inductor coils comprise a first inductor coil and a second inductor coil wherein, in use, the article for use with the aerosol provision device is located equidistant between the first inductor coil and the second inductor coil, and wherein the article does not penetrate inside the first inductor coil and the second inductor coil.

4. The aerosol provision device as claimed in claim 1, wherein at least one of the one or more inductor coils comprises a planar non-spiral inductor coil.

5. The aerosol provision device as claimed in claim 1, wherein at least one of the one or more inductor coils comprises an electrically-conductive element, wherein the electrically-conductive element comprises an electrically-conductive first portion coincident with a first plane, an electrically-conductive second portion coincident with a second plane that is spaced from the first plane, and an electrically-conductive connector that electrically connects the electrically-conductive first portion to the electrically-conductive second portion.

6. The aerosol provision device as claimed in claim 1, wherein at least one of the one or more inductor coils comprises a layered inductor arrangement, wherein the layered inductor arrangement comprises a plurality of layers.

7. The aerosol provision device as claimed in claim 1, wherein at least one of the one or more inductor coils comprises one or more conically shaped inductor coils.

8. The aerosol provision device as claimed in claim 1, wherein the one or more inductor coils are arranged to generate a varying magnetic field and wherein the aerosol provision device further comprises one or more susceptors which are arranged to become heated by the varying magnetic field.

9. An aerosol provision system comprising:
the aerosol provision device as claimed in claim 1; and
the article or a plurality of the articles comprising aerosol generating material.

10. The aerosol provision system as claimed in claim 9, wherein the article or the plurality of the articles are located within or between windings of the one or more inductor coils.

11. The aerosol provision system as claimed in claim 9, wherein the article or the plurality of the articles are substantially planar.

12. The aerosol provision system as claimed in claim 9, wherein the article or the plurality of the articles comprise one or more susceptors.

13. The aerosol provision system as claimed in claim 9, wherein the article or the plurality of the articles comprise aerosol generating material.

14. The aerosol provision system as claimed in claim 13, wherein the aerosol generating material is provided: as a solid; as a liquid; in the form of a gel; in the form of a thin film substrate; in the form of a thin film substrate having multiple regions; or in the form of a thin film substrate having multiple regions, wherein at least two of the regions comprise aerosol generating material having different compositions.

15. A method of generating an aerosol comprising:
providing an aerosol provision device having one or more inductor coils;
interlacing or otherwise locating an article for use with the aerosol provision device within or between at least one of the one or more inductor coils or windings of the one or more inductor coils, wherein the article comprises aerosol generating material; and
energizing the one or more inductor coils or windings.

16. The aerosol provision device as claimed in claim 6, wherein the layered inductor arrangement comprises three or more layers.
